(19) United States
(12) Patent Application Publication
(10) Pub. No.: US 2016/0087713 A1
(43) Pub. Date: Mar. 24, 2016

(54) Methods and Apparatus for Providing Virtual Military Satellite Communication (MILSATCOM) Services Utilizing Shared Spectrum and Orbital Assignments

(71) Applicants: Mark Oderman, Marblehead, MA (US); Scott Anderson, Centennial, CO (US); Eric Anderson, Centennial, CO (US)

(72) Inventors: Mark Oderman, Marblehead, MA (US); Scott Anderson, Centennial, CO (US); Eric Anderson, Centennial, CO (US)

(21) Appl. No.: 14/711,944

(22) Filed: May 14, 2015

Related U.S. Application Data
(60) Provisional application No. 61/992,953, filed on May 14, 2014.

(51) Int. Cl. H04B 7/185; G06Q 20/14

(52) U.S. Cl. CPC H04B 7/18591; H04B 7/18513; G06Q 20/145

(57) ABSTRACT

A virtual military satellite communication (Virtual MILSATCOM) network is described which supplements an existing military satellite communication (MILSATCOM) network in a manner consistent with existing Department of Defense funding issues, and a pricing model is provided to provide better pricing for expanding usage in the future. Co-location of Virtual MILSATCOM satellites and existing MILSATCOM satellites supports existing legacy users while providing more efficient usage of existing X-band frequencies.

This application claims the benefit of U.S. Provisional Patent Application Ser. No. 61/992,953 entitled “Methods and Apparatus for Providing Virtual Military Satellite Communication (MILSATCOM) Services Utilizing Shared Spectrum and Orbital Assignments” filed on May 14, 2014 which is hereby incorporated by reference in its entirety.

### FIELD OF THE INVENTION

The present invention relates generally to advantageous approaches to improving on existing satellite communication and more particularly to approaches for providing virtual satellite services, such as MILSATCOM services.

### BACKGROUND OF THE INVENTION

Since U.S. forces often operate in areas where terrestrial communications infrastructure is inadequate or unavailable, satellite communications are often the only solution. Satellite networks have become an indispensible component of modern military operations worldwide.

Acquisition of satellite communications capacity by the Department of Defense (DoD) is typically based on two acquisition or operating methods. The traditional military satellite communications network (MILSATCOM) acquisition method historically preferred by the DoD involves the design, development and acquisition of satellites designed specifically for DoD requirements using development contracts funded through budget line items. This approach takes many years, is very expensive, and limits the opportunity for military satellite operators and users to benefit from rapidly evolving satellite communications technology. The DoD has built and operated its own MILSATCOM since the 1960s. The U.S. government has coordinated a large number of orbital slots on the geostationary orbit for MILSATCOM assets. As referred to in this application “coordination” refers to the regulatory process by which DoD's orbital slots are coordinated and registered with the International Telecommunication Union (ITU). Once an orbital slot is coordinated, the operator has full authority to use the slot within designated technical parameters, and conversely other operators must ensure that their satellites do not cause interference.

MILSATCOM satellites have been funded and operated as DoD weapons systems. A DoD development agency, such as the U.S. Air Force's Space and Missile Systems Center, is responsible for defining requirements, awarding a development contract, overseeing the development and delivery of the satellite, and contracting the launch of the satellite into orbit. Other DoD agencies then usually assume responsibility for operating and tasking the satellite. These satellite systems are tightly integrated into larger, secure DoD communications networks.

A second commercial satellite communication (COMSATCOM) procurement method involves the lease of capacity from commercial satellite operators through a government services contract. This approach enables access to the most modern commercially available satellite capacity, but does not guarantee availability, is subject to fluctuations in pricing based on market conditions outside of DoD's control, and is generally less secure than MILSATCOM.

The military prefers to use its own dedicated MILSATCOM systems when possible. As compared with commercial communications satellite systems, MILSATCOM satellites use distinct frequencies, and incorporate features that are intended to reduce their susceptibility to intentional jamming and/or interference. Operational security (OPSEC) of these assets is also superior, since the satellites and communications gateways are operated by military personnel or contractor personnel, and connect directly to secure terrestrial defense communications networks. The MILSATCOM architecture includes a wideband segment that carries the majority of total traffic. Wideband satellites operate in designated frequencies that have been assigned to government use under the spectrum management framework of the International Telecommunication Union. X-band and Ka-band frequency bands are both used for military wideband communications. The other segments are the ultra-high frequency (UHF) mobile segment that provides low data rate communications to mobile platforms and users using small omnidirectional antennas, such as those analogous to a car radio or cellular telephone antenna, and the extremely high frequency (EHF) protected segment, which provides ultra-secure, low probability of detection/low probability of interception communications for the national command authority and select strategic users.

The U.S. Air Force's Wideband Global Satcom (WGS) constellation is its current generation of wideband MILSATCOM satellites. The WGS architecture provides a high capacity Ka-band communications payload and an X-band communications payload.

Military end users are not directly charged for the costs of the MILSATCOM capacity, as these costs are typically paid for in traditional DoD system acquisition and operations contracts, and the personnel costs of the military and civilian personnel assigned to manage and operate those programs. However, the ability of military end users to access the satellites is usually determined by an allocation process that ranks the priority of all users. In practice, demand always exceeds available MILSATCOM supply, a condition that is worsening due to the increased role of network-centric operations, and the increasing use of bandwidth intensive applications such as high definition video feeds taken from airborne surveillance and reconnaissance sensors. If the total demand for capacity is greater than the capacity available, lower priority users either go without service, or must find an alternate source of capacity, usually through the COMSATCOM procurement process.

The traditional MILSATCOM approach described above has been used by the DoD for almost fifty years. However, it has several weaknesses. First, the government processes for developing and deploying MILSATCOM satellites require the government to fund large, up-front capital expenditures for research and development and procurement of satellites for several years before any capability is delivered. The development and deployment cycle for a satellite network can take 10-15 years, and the satellites then operate for another 10-20 years on orbit. By the time a MILSATCOM constellation of satellites is fully deployed, it may be technologically obsolete, and may no longer meet the capacity and/or coverage needs of military users.

These drawbacks are evident in the recent history of wideband communications. Today's WGS system was originally envisioned as a gapfiller system that would be replaced by a much more capable Transformational Satellite (TSAT) architecture. However, the TSAT program was cancelled in 2010 due to schedule delays, technological challenges and significant cost growth. Consequently, the U.S. Air Force expanded its procurement of WGS satellites from the three satellites originally planned, ultimately to ten. However, even with an increase in the number of WGS satellites, military requirements for wideband satellite communications have expanded much more rapidly than the capacity of the DoD's dedicated MILSATCOM network. Replacement of the WGS network is not likely until the mid-2020s, in large part due to the estimated time it will take to develop a replacement MILSATCOM system, and due to the high expected costs of that program.

Lacking sufficient dedicated MILSATCOM capacity, the DoD has turned to commercial satellite communications networks (COMSATCOM) to meet its growing needs. It is estimated that as much as 50-80% of DoD's satellite communications traffic has been carried on COMSATCOM networks.

COMSATCOM has its own drawbacks. First, DoD cannot guarantee that COMSATCOM capacity will be available when and where it is needed. When military demand for satellite communication capacity grew dramatically to support operations in Southwest Asia, the commercial satellite communication market had significant excess capacity at that time, and DoD was able to secure bandwidth at reasonable rates. However, as military and commercial demand continued to grow, needed capacity was increasingly difficult and costly to obtain. The only way that DoD can ensure that it has sufficient capacity from traditional COMSATCOM operators is to acquire and maintain that capacity before it is needed. This solution is an inefficient and expensive one, as DoD's requirements are driven by varying mission requirements, and capacity that is acquired years in advance may be unused for long periods of time, or worse, may be in the wrong location to meet demand. Second, DoD's budget process and unpredictable requirements have led military customers to rely upon short-term leases, often of one year duration or less, for capacity on the expensive spot market. This practice leaves DoD exposed to higher prices generally, and to the pricing swings that can occur when there is limited unused capacity available to serve a region of interest. DoD's recent experience shows that transponder prices, measured in $/MHz/month, rose substantially between 2003 and 2010 as utilization rates on commercial satellites grew. Commercial operators have advocated that DoD change its acquisition policies so that it can more readily enter into long term leases. Long term leases would guarantee DoD access to the capacity at better prices than short term leases. However, since DoD demand is inherently unpredictable, and leases are typically for specific capacity on a specific satellite with a specific footprint, long term leases could result in paying for capacity that isn't always needed or used.

Third, commercial communications satellites are not designed with military operations in mind. In particular, they are susceptible to intentional jamming, unintentional jamming, as well efforts to intercept signals. Inadvertent interference is already a cause of concern among commercial operators, but they have not yet hardened their satellites against deliberate efforts to jam or incapacitate them. Moreover, if a commercial satellite carrying DoD traffic were deliberately jammed to prevent DoD utilization, it is unclear how commercial operators would respond. Would they continue to accept DoD traffic, knowing that it jeopardizes the operations of their other commercial customers? Would they demand higher prices for that risk, or would they refuse to lease capacity needed by DoD unless they were indemnified against losses in their commercial business?

A further point is that DoD's use of COMSATCOM compromises the security of military communications. While DoD and the commercial operators do not announce which satellites and transponders are being used for what purpose, it is not difficult for adversaries to monitor commercial satellites or infer when military demand is rising or falling. In fact, most satellite operators report the percentage of their revenues earned from government customers. The visibility of DoD's use of COMSATCOM is itself a liability as it provides an indication of military preparations or operations.

Ownership of COMSATCOM networks is also an issue of concern. Most of the global wideband satellite communication networks, and all of those outside of North America, are owned by foreign companies, using satellites that have been acquired from non-U.S. sources, usually launched from outside of the United States, operated in foreign locations by foreign nationals, and connected to foreign local domestic communications networks. DoD has expressed concerns that these operators and their satellite networks may be more vulnerable to cyber security breaches or operational interference.

For these reasons and others, the DoD has indicated that it would prefer to lessen its reliance on COMSATCOM sources. The conundrum for DoD is that military bandwidth demand continues to grow, while the ability to fund and deploy new MILSATCOM using the traditional acquisition processes cannot keep up. The net result is that DoD is increasingly reliant on COMSATCOM over which it has limited control and which is a less than ideal solution for military users.

### SUMMARY OF THE INVENTION

The present invention enables the DoD, as well as other operators of dedicated satellite communications networks, a cost effective and rapid path to upgrade and expand the communications capacity of their existing orbital slots and frequencies through seamless integration of new Virtual MILSATCOM capacity with existing MILSATCOM systems.

Aspects of the Virtual MILSATCOM methods and systems described herein uniquely combine features of MILSATCOM and COMSATCOM. These new methods and systems provide significant improvements in the provision of satellite communications services to meet the Department of Defense's growing and evolving needs. No existing satellite communications systems and methods, either military or commercial, can deliver all of these benefits.

The applicants have carefully studied the current MILSATCOM and COMSATCOM methods and have developed a new and innovative approach referred to herein as “Virtual MILSATCOM”. Virtual MILSATCOM offers government operators the ability to dynamically expand MILSATCOM fleet capacity, improve operational flexibility, maintain security, enhance resiliency, take advantage of rapidly evolving commercial satellite technology, and achieve significant reductions in the cost of satellite bandwidth as compared with current MILSATCOM and COMSATCOM costs and prices, while supporting any legacy systems deemed important.

Several features in combination enable a presently preferred embodiment of this model. No other satellite communications system architecture—past, current, or proposed—combines these features in the manner addressed herein. The combination of these features creates and maximizes the unique value of the Virtual MILSATCOM approach as addressed further below. Aspects of the present invention which, taken in various combinations, make this approach novel and unique include the following:

Virtual MILSATCOM satellites can be dynamically operated with existing MILSATCOM assets and share use of DoD's coordinated geostationary orbital assignments, radio frequency spectrum and geographic coverage footprints. Dynamic in this context refers to the integration of the planning and operation of MILSATCOM and Virtual MILSATCOM networks in real time to provide superior service metrics. Dynamic co-location refers to the ability to share the available bandwidth and coverage pattern, or footprints between the MILSATCOM and Virtual MILSATCOM satellites operating in a single orbital location, and to reallocate the spectrum and coverage patterns in a centrally controlled command and control architecture. Virtual MILSATCOM satellites may also operate dynamically in separate orbital slots from existing MILSATCOM satellites, where they would have access to the entire authorized frequency allocation, but with overall traffic allocation, coverage patterns, and terminal assignments tightly coordinated with the existing MILSATCOM network. Also, because of the unique configurability of the Virtual MILSATCOM satellites, multiple Virtual MILSATCOM satellites can be operated from a single orbital location.

Advanced digital channelization, spot beam technology, and advanced beam forming are employed by Virtual MILSATCOM satellites to significantly improve the total throughput capacity of DoD's existing frequency allocations, such as X-band and Ka-band, and to dynamically adapt beam patterns to traffic requirements. In one aspect, Virtual MILSATCOM will offer a minimum 5×, and as much as 20× improvement in the capacity using digital channelization and beamforming as compared to existing X-band MILSATCOM satellites. With the use of advances in commercial terminal and waveform technology, Virtual MILSATCOM can yield up to an additional 2-4× improvement in communication data rates on top of the improvements resulting from digital channelization and beamforming.

According to one aspect of the invention, Virtual MILSATCOM satellites operate only on DoD's coordinated frequencies, and are not accessible to any other party without DoD's approval. This operational approach allows the Virtual MILSATCOM satellites and network to be optimized for DoD operating requirements, including the ability to reconfigure and relocate satellites as necessary to meet changing global coverage requirements.

Virtual MILSATCOM satellites incorporate unique design features and support a service pricing model with respect to routine orbital relocation and evasive maneuver. Virtual MILSATCOM satellites are preferably designed for multiple fast relocations from one orbital position to another. This approach enables the Virtual MILSATCOM satellites to be repositioned in less than half the time that would be required for a traditional relocation. Virtual MILSATCOM satellites will also incorporate the capability to perform evasive maneuvers in the event that a physical threat is launched against the satellite. These repositioning capabilities are offered as standard services.

Virtual MILSATCOM incorporates a unique Company Owned Customer Operated concept of network operations that gives the customer full operational authority over the Virtual MILSATCOM communications payloads, up to and including full control over the normal scheduling, tasking and monitoring of the satellite payload, using DoD control facilities if desired. This operational control includes giving DoD the full authority to direct the Virtual MILSATCOM operator to reconfigure the coverage pattern of a satellite, or move the satellite from one location to another.

One Virtual MILSATCOM pricing model uses schedules based on the level of capacity measured across the entire satellite network, rather than the traditional approach of acquiring capacity on a designated transponder on a specific satellite. This system-level approach reduces the cost to Virtual MILSATCOM customers of moving traffic from one satellite to another. Another optional feature for Virtual MILSATCOM is a “take-or-pay/declining incremental cost” structure which provides the Virtual MILSATCOM customer with predictable pricing over the operating lifetime of the satellite network.

By using existing, coordinated MILSATCOM frequencies, Virtual MILSATCOM capacity is immediately accessible to the large existing population of DoD satellite terminals.

The Virtual MILSATCOM system owner will preferably be a U.S. owned and U.S. operated company that can hold all necessary personnel and facility clearances necessary to enable full integration of the Virtual MILSATCOM assets into the existing MILSATCOM architecture. This secure approach may include the ability to place the virtual MILSATCOM operator's ground-based control facilities and gateways at DoD sites in the United States and abroad for enhanced physical, communications, cyber and operational security.

Virtual MILSATCOM architecture may advantageously utilize modern small commercial communications satellite buses to lower development cost and hence service pricing to DoD customers, as well as enable the option to utilize launch services from multiple launch service providers including new low cost, U.S. launch service providers.

According to one aspect, the Virtual MILSATCOM owner will finance the construction, launch and operation of the Virtual MILSATCOM network, and will manage economic risk through multiple means including the use of commercial satellite insurance facilities for launch and on-orbit insurance, thereby enabling rapid recovery from any launch or on-orbit failure without budgetary exposure to DoD.

These and other features, aspects, techniques and advantages of the present invention will be apparent to those skilled in the art from the following detailed description, taken together with the accompanying drawings and claims.

### BRIEF DESCRIPTION OF THE DRAWINGS

FIG. 1 shows a system of co-locating a Virtual MILSATCOM X-band satellite with a preexisting MILSATCOM satellite employing dynamic X-band frequency sharing in accordance with an embodiment of the present invention in a co-located operation;

FIG. 2 shows a further embodiment of the present invention employing dynamic Virtual MILSATCOM X-band beam optimization;

FIG. 3 shows a further embodiment of the present invention employing dynamic frequency sharing and beam optimization;

FIGS. 4 and 5 illustrate advantageous aspects of beam footprints readily provided by Virtual MILSATCOM X-band systems and methods in accordance with the present invention;

FIG. 6 illustrates examples of advantageous Virtual MILSATCOM special mission beams;

FIG. 7 illustrates a MILSATCOM and Virtual MILSATCOM system in accordance with a further embodiment of the present invention;

FIG. 8 illustrates a further embodiment in which the assets of the embodiment of FIG. 7 are redeployed;

FIG. 9 illustrates a prior art process of orbital insertion and relocation of a Virtual MILSATCOM satellite in accordance with the present invention;

FIGS. 10 and 11 illustrate prior art orbital relocation employing East drift or West drift, respectively;

FIGS. 12 and 13 illustrate aspects of Virtual MILSATCOM relocation drift rate profiles in accordance with an embodiment of the present invention;

FIG. 14 compares relocation capability of the Virtual MILSATCOM satellite in accordance with FIGS. 12 and 13 with typical COMSATCOM satellite design;

FIG. 15 illustrates trade-offs between satellite mass, relocation fuel reserve and evasive maneuver fuel reserve in satellite systems and methods in accordance with aspects of the present invention;

FIG. 16 illustrates aspects of a MILSATCOM and Virtual MILSATCOM integrated architecture in accordance with the present invention;

FIG. 17 illustrates aspects of a MILSATCOM architecture supplemented by COMSATCOM architecture as done in the prior art for comparison with the approach of FIG. 16;

FIG. 18 shows a table of satellite and system fill rates under various scenarios;

FIG. 19 illustrates a method of Virtual MILSATCOM pricing under the scenarios of FIG. 18;

FIG. 20 shows a diagram of a combination of features of Virtual MILSATCOM according to one embodiment of the invention;

FIG. 21 shows a Virtual MILSATCOM process in accordance with the present invention;

FIG. 22 shows a further Virtual MILSATCOM process in accordance with a further aspect of the present invention;

FIGS. 23A and 23B show an exemplary Virtual MILSATCOM satellite controller in accordance with the present invention, and a block diagram of a digital channelizer beamformer suitable for use in FIG. 23A, respectively; and

FIG. 24 shows an exemplary Virtual MILSATCOM satellite system controller in accordance with the present invention.

### DETAILED DESCRIPTION OF THE DRAWINGS

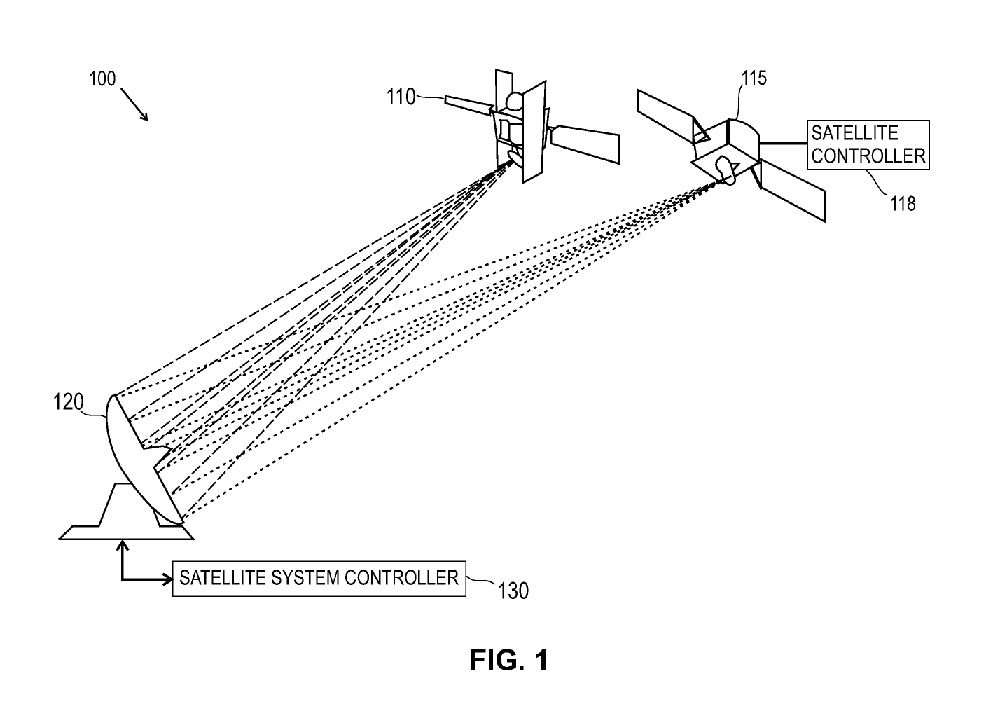

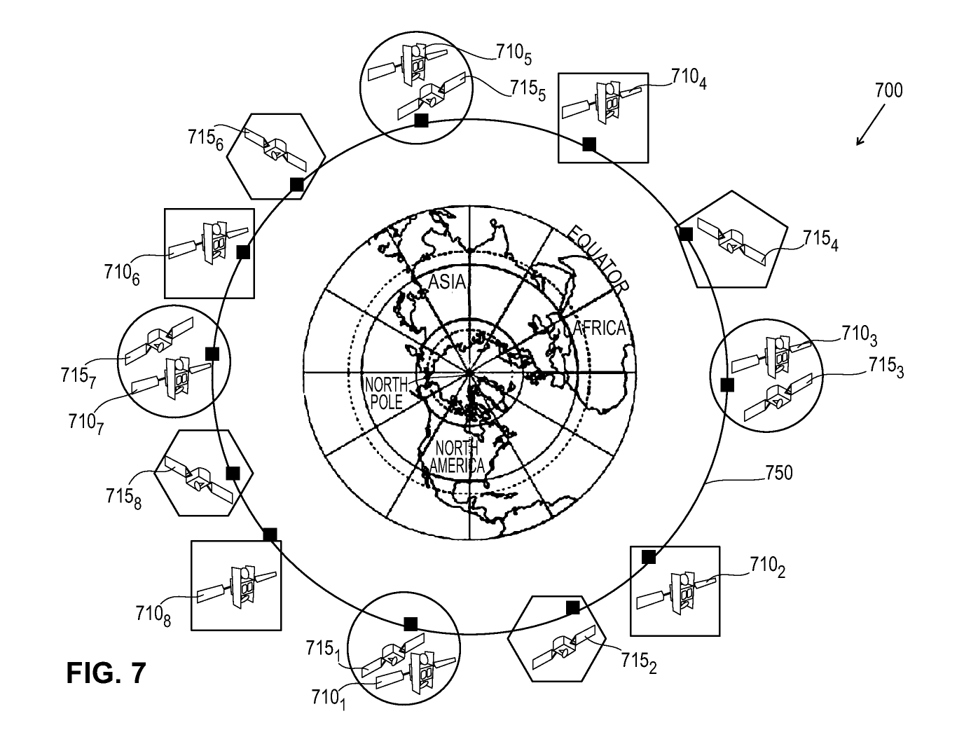

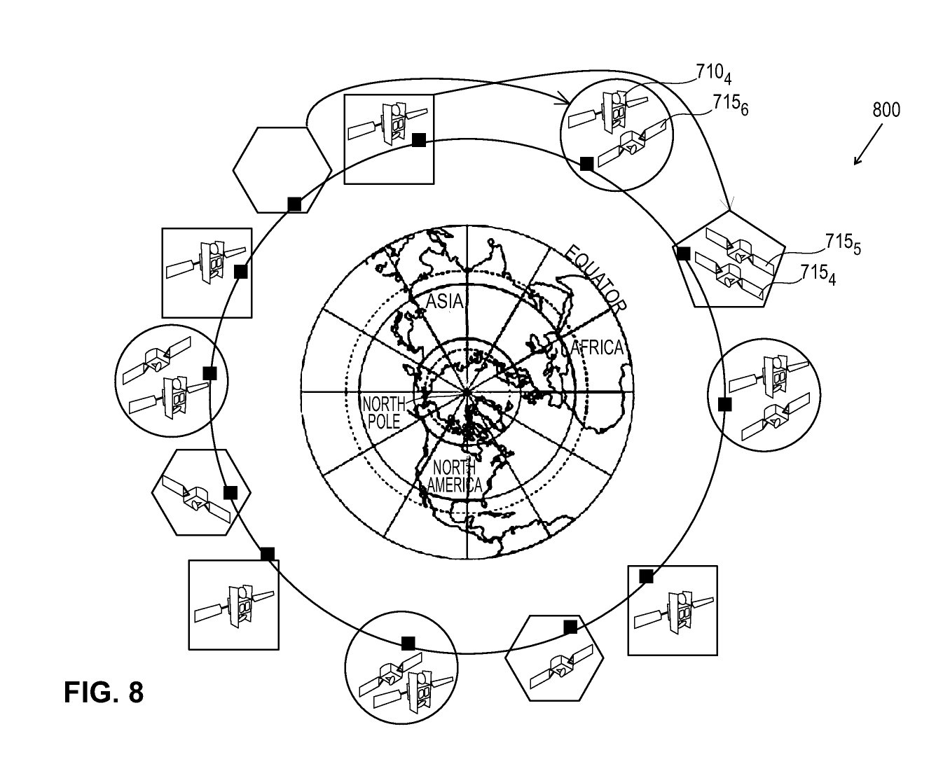

FIG. 1 shows a Virtual MILSATCOM system 100 in which a Virtual MILSATCOM satellite or satellites use an existing government orbital slot or slots and frequency assignments. Virtual MILSATCOM satellites can be co-located with existing government-owned MILSATCOM satellites, such as the U.S. Air Force's Wideband Global Satcom (WGS) network. More particularly, FIG. 1 shows a first satellite 110, a MILSATCOM satellite with an X-band transmitter and receiver 112 with a ground antenna 120 bidirectionally communicating with satellite system controller 130. In addition to the first MILSATCOM satellite 110, there is a co-located second satellite 115, a Virtual MILSATCOM satellite with an X-band transmitter and receiver 117 communicating with the ground antenna 120. When satellites, such as satellites 110 and 115 are co-located in orbit, within 0.1 degrees, they appear as a single satellite to Earth stations, such as station 120. The satellite 115 includes a satellite controller 118 which controls its operation as addressed further herein. While first and second satellites 110 and 115 are illustrated in FIG. 1 for ease of illustration, it will be recognized that multiple satellites will typically be deployed in a system 100 at multiple orbital locations, as further illustrated in FIGS. 7 and 8, for example. Also, it will be recognized that more than one Virtual MILSATCOM satellite can be co-located with an existing MILSATCOM satellite. Additionally, or alternatively, Virtual MILSATCOM satellites can be placed in any locations that have been coordinated by the DoD for wideband communications but which are not currently in use, or in other locations that have been independently coordinated by the Virtual MILSATCOM satellite operator.

According to one aspect of the invention, a first generation Virtual MILSATCOM satellite in accordance with the present invention is designed to exploit the entire 500 MHz of X-band spectrum allocated to DoD MILSATCOM. It is anticipated that a next generation Virtual MILSATCOM satellite will be designed to utilize the 1000 MHz of Ka-band spectrum coordinated at these slots. A single Virtual MILSATCOM satellite could also be designed to provide services in both frequency bands, just as WGS does today. When Virtual MILSATCOM satellites are co-located with existing MILSATCOM satellites, the available frequencies can be shared with existing MILSATCOM assets to optimally tailor coverage and capacity, using frequency separation, spatial separation, frequency polarization or any combination thereof.

Co-location has been routinely used as a mechanism for the orderly transition of traffic from one satellite to another, for example, when a new satellite is deployed to replace one that is approaching the end of its operational life. Another instance in which co-location has been practiced is when two satellites share a common orbital location but operate at different, non-overlapping frequencies, for example, a satellite operating in C-band may be co-located with a satellite operating in Ku-band. A third situation arises when satellites operating on the same frequency are providing coverage in geographically distinct coverage areas. In these situations, the payload planning and control of the co-located satellites remain operationally separate.

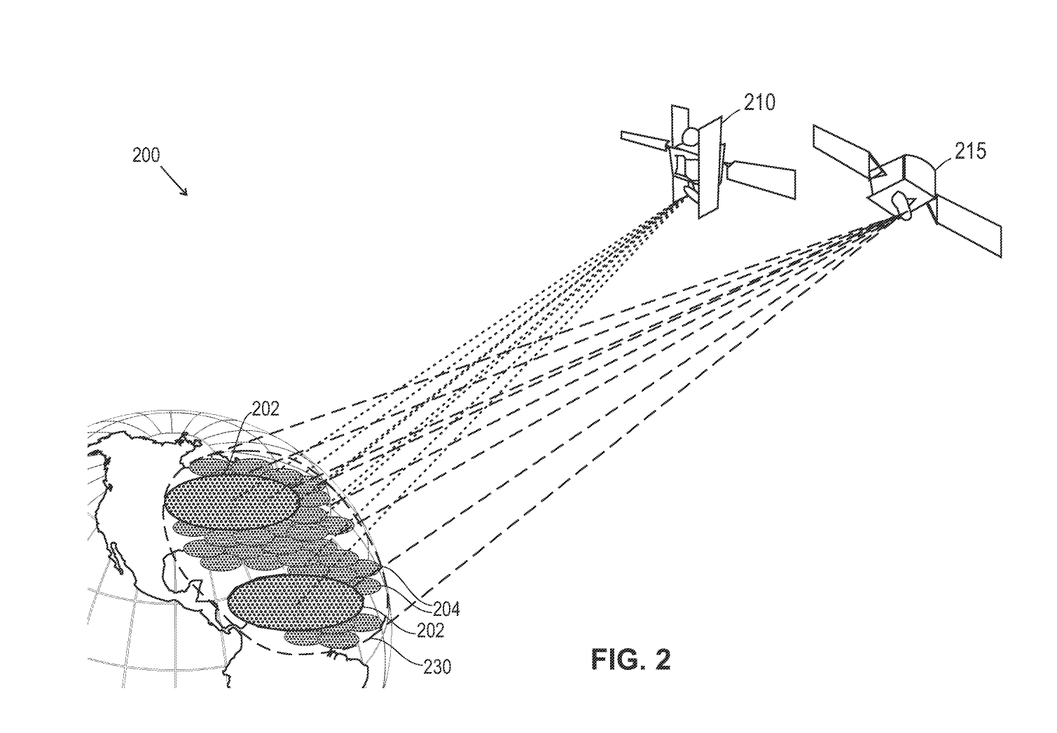

Virtual MILSATCOM satellite operation in accordance with the present invention exploits co-location in new and unique ways. Virtual MILSATCOM expressly enables and exploits the sharing of frequency and coverage footprints of the Virtual MILSATCOM and MILSATCOM satellites. Because of the tight operational coupling of the MILSATCOM and Virtual MILSATCOM satellites, such as satellites 110 and 115, respectively, they can be operated as a single, synthetic satellite. One mode where this allocation is effected is shown in FIG. 1. FIG. 1 depicts a situation in which the 500 MHz of available spectrum is split between the two satellites 110 and 115. For example, for a downlink frequency range of 500 MHz, such as from 7.25 to 7.75 GHz, n MHz of the 500 MHz allocation are assigned to satellite 110 and the remainder (500-n) MHz are assigned to satellite 115. Thus, both satellites 110 and 115 can cover the same area, with overlapping beams without interfering with each other. The frequencies allocated to the existing wide area MILSATCOM satellite 110 support applications that need wide area coverage, while the frequencies utilized by the Virtual MILSATCOM satellites can advantageously be reused many times in a high-throughput spotbeam architecture as seen in FIG. 2. With dynamic frequency-sharing, the frequency allocations between the two or more co-located satellites can be adjusted as mission requirements dictate. This operational flexibility does not exist in either the MILSATCOM or COMSATCOM markets today.

FIG. 2 illustrates a dynamic beam optimization system 200, another advantageous feature enabled by the Virtual MILSATCOM approach. In this mode, larger MILSATCOM beams 202 and narrower Virtual MILSATCOM beams 204 produced by MILSATCOM satellite 210 and a co-located Virtual MILSATCOM satellite 215, respectively, are woven together into an integrated, contiguous footprint 230. In FIG. 2, the larger MILSATCOM beams 202 can be configured for n megahertz (MHz) of bandwidth and the smaller Virtual MILSATCOM beams 204 would then use the reuse the remaining frequency (500-n)MHz. In this architecture, the larger beams 202 would support surface areas with lower user traffic density, or in which specific missions are optimized with a widebeam format. The smaller beams 204 would support higher density traffic areas, or areas in which a smaller spot beam would enhance mission effectiveness. Moreover, as with dynamic frequency sharing, these configurations are flexible and can be adapted as requirements change. This level of integration requires careful coordination of the MILSATCOM and Virtual MILSATCOM assets, such as satellites 210 and 215.

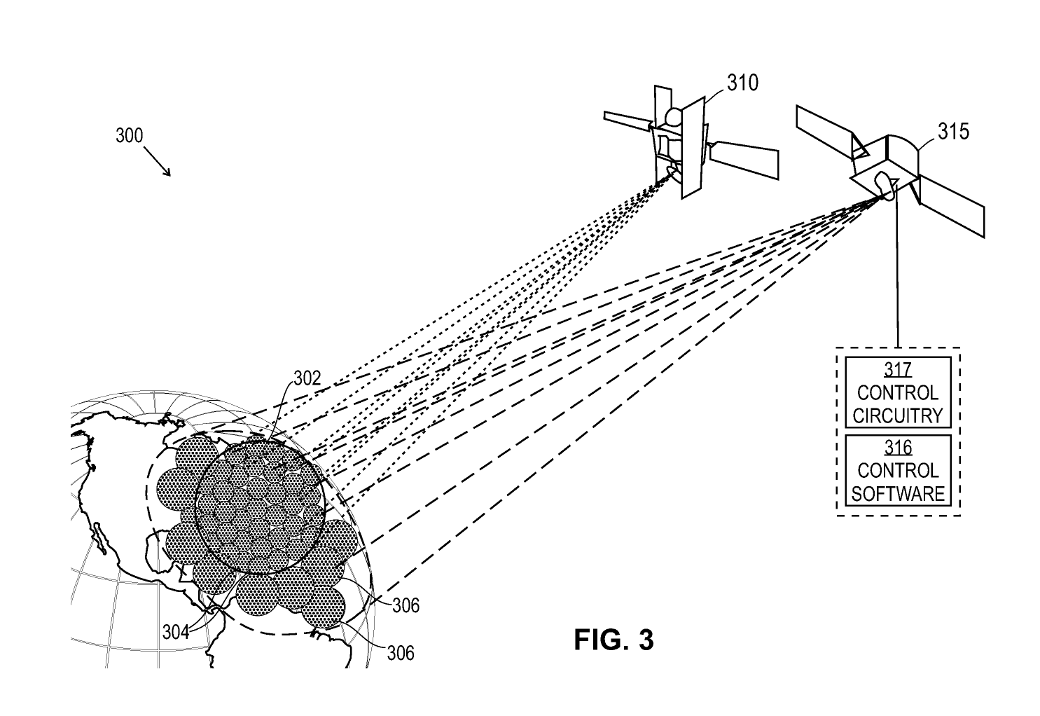

FIG. 3 shows a Virtual MILSATCOM system 300 in which an existing MILSATCOM satellite 310 and a co-located Virtual MILSATCOM satellite 315 are operated to utilize both dynamic frequency sharing and dynamic beam optimization. In FIG. 3, a large MILSATCOM beam 302 is allocated n MHz of spectrum. Smaller Virtual MILSATCOM spot beams 304 overlaid on this beam 302 would share or reuse the remaining spectrum, (500-n) MHz. Outside of the overlap region, the Virtual MILSATCOM architecture would have access to the full 500 MHz of spectrum, and could be allocated in variable beam sizes, such as illustrative beams 306, which are larger than beams 304, as dictated by traffic requirements. With suitable beam forming control software 316 and control circuitry 317 inside Virtual MILSATCOM satellite 315, but illustrated in FIG. 3 externally for ease of illustration, the Virtual MILSATCOM satellite can generate, within the power and processing limits of the satellite, beams of varying size and capacity. This approach provides a level of frequency optimization that has not been implemented on any prior co-location effort.

At the time of WGS development, DoD planned to migrate MILSATCOM to higher RF and optical frequencies, so little effort was made to improve the efficiency of X-band utilization. The current X-band payload used on WGS has only modest improvements, in terms of capability, from the payload that was developed for the earlier generation of Defense Satellite Communications System (DSCS) satellites that were designed in the 1980s. The current WGS X-band payload typically comprises electronically steered zone beams and a single global beam. With this configuration, the X-band payload typically provides less than 2 GHz of usable X-band spectrum, which is laid down in large beam footprints which are often more than 1000 miles in diameter. Within each large zone, only 500 MHz of bandwidth is available to meet the needs of all users.

The Virtual MILSATCOM communications payloads of the present invention advantageously bring a new generation of digital channelizer and beam forming technology to the wideband MILSATCOM arena for improvement of spectrum utilization. An initial deployment of Virtual MILSATCOM is expected to occur in the X-band frequency spectrum. However, the Virtual MILSATCOM model is applicable to other frequency bands. For example, the DoD's WGS system also operates in a segment of the Ka-band spectrum that has been reserved for government use. The Virtual MILSATCOM approach represents a significant improvement over existing MILSATCOM approaches, offering more total capacity through spatial frequency reuse in spot beams and greater tailoring of capacity to the expected user needs.

Virtual MILSATCOM satellites in accordance with the present invention may advantageously incorporate advanced digital channelization to greatly expand capacity and flexibility. Whereas the WGS X-band has eight spot beams, the Virtual MILSATCOM satellites can generate thousands of unique beams that are tailored to user requirements.

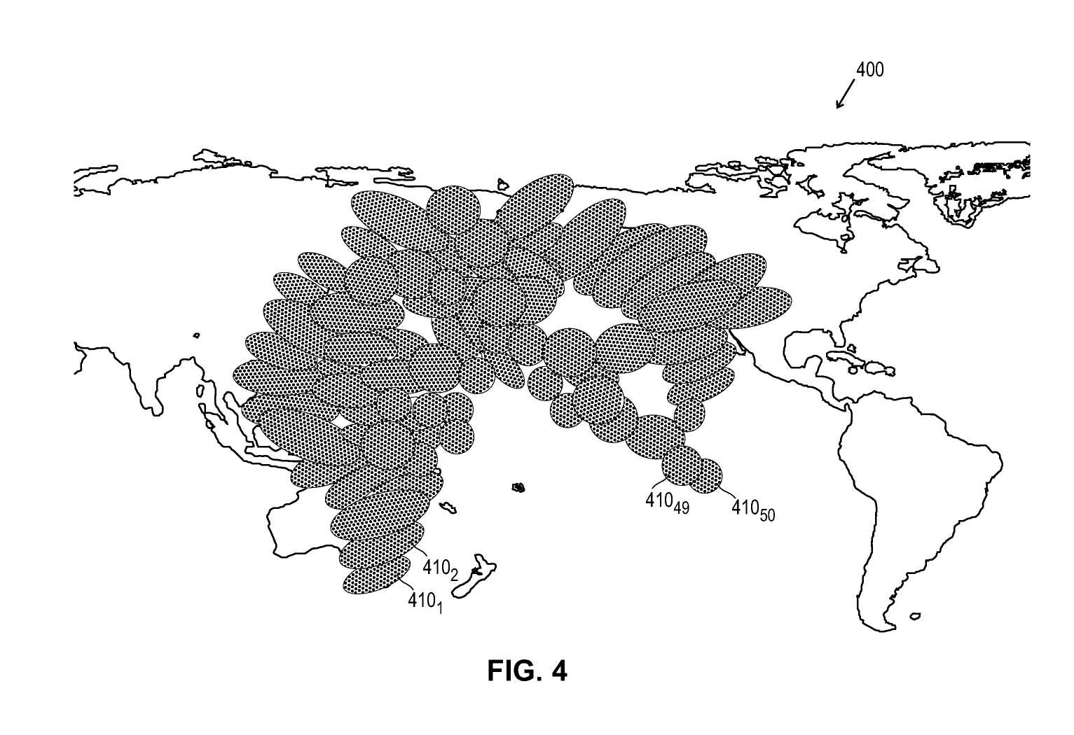

The total capacity of a particular Virtual MILSATCOM satellite is a function of the throughput capabilities of the channelizer. A low cost satellite could readily provide 10 GHz of bandwidth processing, and 20 GHz is within current technology. An illustrative selection of beam footprints is presented in FIGS. 4-6. FIG. 4 presents a wide area coverage pattern 400 in which 10 GHz is allocated among fifty beams 410₁, 410₂, . . . , 410₄₉, 410₅₀ of varying size to match expected traffic density. It is noted that the illustrative pattern 400 of FIG. 4 represents only one possible wide area footprint.

As compared with the current WGS X-band payload, the configuration presented in FIG. 4 would have roughly five times the total throughput capacity (10 GHz vs. ˜2 GHz) over a large service area.

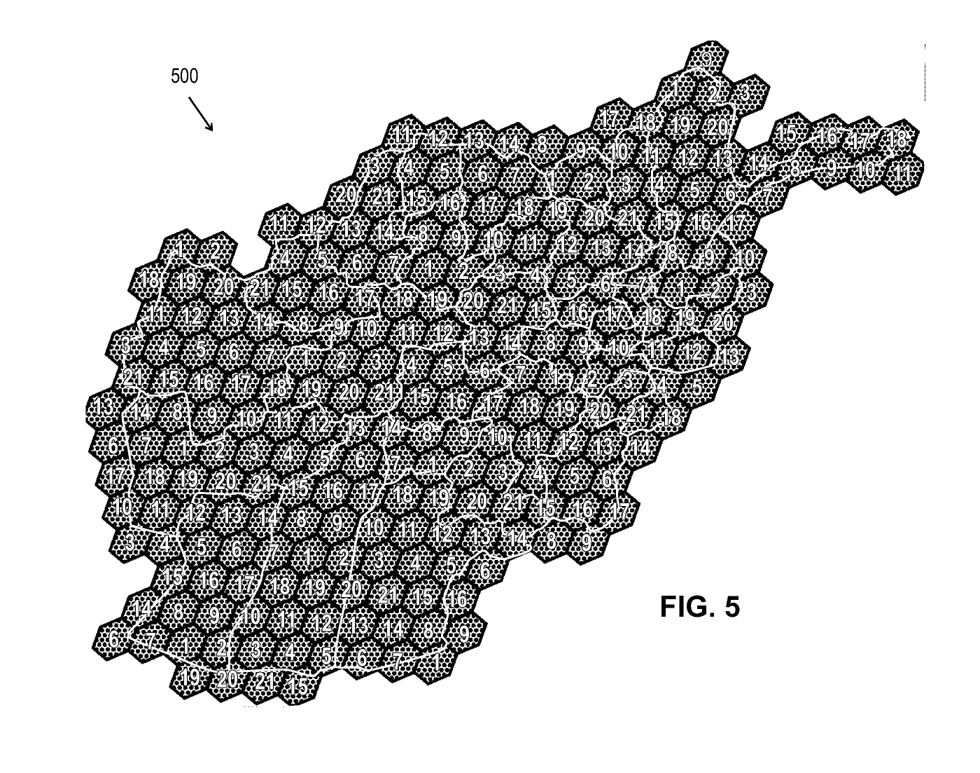

By contrast, FIG. 5 presents a high density scenario 500, in which all of the 10 GHz of capacity is focused in very small beams that “paint” a very tightly focused geographic area. In this configuration, the Virtual MILSATCOM satellite can provide up to 20 times the capacity, 10 GHz vs. 500 MHz, within a theater of interest, such as Afghanistan. In this example, the entire capacity of the Virtual MILSATCOM satellite is focused in a geographic area smaller than the diameter of a single WGS spot beam.

Virtual MILSATCOM also improves the channel resolution compared with existing MILSATCOM. The minimum channel width on WGS is 2.6 MHz. The channelization capability of the satellite limits WGS to a maximum of 432 simultaneous users. Thus, while WGS can provision 2.6 MHz channels, if it were to do so, it would provide only 1.1 GHz of spectrum. The Virtual MILSATCOM architecture described herein will improve channelization limits to 1 MHz or smaller, thus providing efficient transmission rates for smaller tactical echelons. With 1 MHz channelization, each satellite would be capable of supporting up to 10,000 simultaneous users (10,000×1 MHz=10 GHz), as much as a 20 fold increase in the potential number of unique user terminals that could be supported.

Digital beam forming is a significant technical advance that will also be delivered by the Virtual MILSATCOM architecture. In essence, digital beam forming uses software to electronically define and configure the coverage patterns generated by the satellite. Instead of launching a satellite with predetermined coverage footprints, the use of digital beam formation enables the size and shape of all beams to be defined and calibrated after the satellite has been launched into orbit. This capability does not exist on WGS or on any commercial wideband communications satellite in operation today.

The Virtual MILSATCOM beam footprint would be optimized to user requirements and may result in set-up of more or fewer beams, larger or smaller beams, symmetrical and non-symmetrical beams, non-stationary or tracking beams. All of these might be adjusted on an ongoing basis to meet changing needs. The beamformer can be used not only to configure the shape and diameter of the beam, but also to determine how much bandwidth is carried within each beam, and the power level of the transmission within each beam. Thus, while all users within a WGS beam must share that bandwidth, and receive the same signal performance, the Virtual MILSATCOM beams can be uniquely configured for individual terminals.

Digital beam forming also has many significant benefits to the operator of the satellite. For example, small beams can be generated in areas with high traffic density, while larger beams can be generated for areas with low traffic demand. Beams can also be designed for almost any shape, not just the circular or oval footprints typical of normal spot beam satellites. Most importantly, these beam patterns can be easily changed to meet changing demands from the ground, both in terms of where the capacity is needed, and the amount of bandwidth needed by individual users.

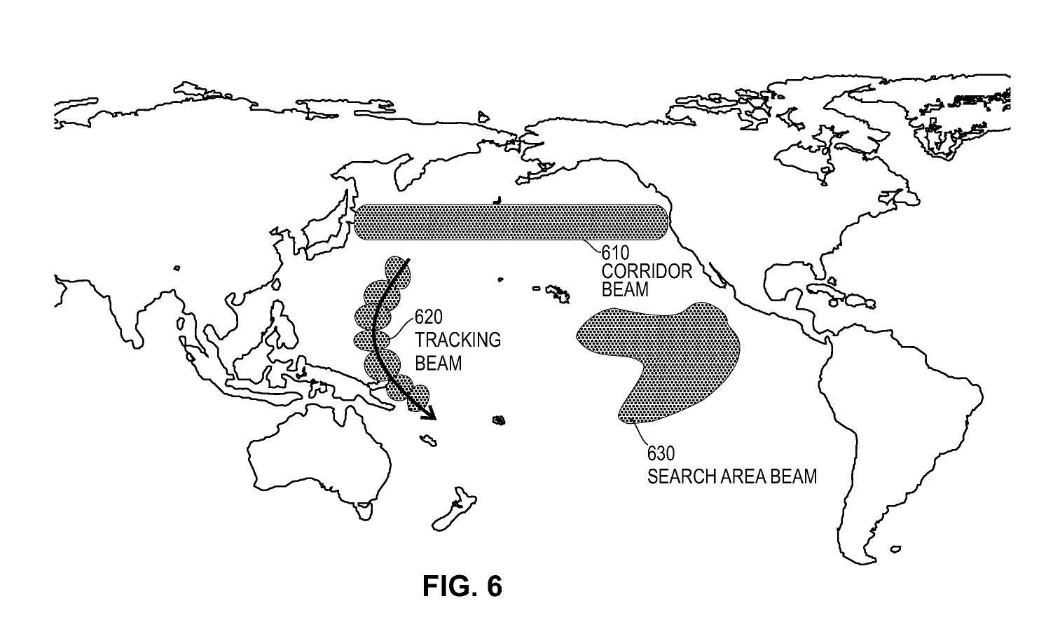

As noted above, digital beamforming enables the satellite to build up and tear down unique beams shaped for specific missions as needed. FIG. 6 depicts three exemplary options, a corridor beam 610 that could support a highly trafficked transit route; a tracking beam 620 that could follow a specific asset, such as an airborne ISR platform or a surface ship group, for example; and a search and rescue beam 630 that could be used to provide focused coverage of a specific geographic area of interest for a search and rescue operation.

Digital beam forming provides the Virtual MILSATCOM approach with additional benefits. First, it standardizes the design of the Virtual MILSATCOM satellite fleet, thereby reducing manufacturing cycle times and reducing costs. Second, because the satellites can be configured and reconfigured in orbit, they can meet adapt to changing requirements at a given orbital location, and be quickly and easily reconfigured after relocation to a new orbital slot. This reconfigurability is an important operational feature. In periods where there is a surge in demand, two or more Virtual MILSATCOM satellites can be co-located and be configured together to provide hundreds or thousands smaller spot beams to deliver additional capacity to the area of interest. When the mission is completed, the satellites can be repositioned to their original locations and beam footprints. Third, digital beam forming will also reduce the cost and complexity of building satellites, as the expensive and customized practice of building antennas for a specific footprint can be replaced with a generic hardware design that is optimized in orbit for coverage requirements. Pre-launch testing and calibration requirements for the antenna system can also be reduced, since software adjustments can correct signal anomalies resulting from the performance of the satellite hardware.

Further, Virtual MILSATCOM may advantageously incorporate dual polarization, a feature that the DoD has not applied to its X-band fleet. The WGS X-band system uses circular polarization, but only uses the left-handed polarization. Virtual MILSATCOM satellites can advantageously incorporate both left-handed and right-handed polarization. With dual polarization, a Virtual MILSATCOM satellite can effectively deliver twice as much capacity in any single beam. To effect this shift, ground terminals also must be upgraded to operate in dual polarization mode. The Virtual MILSATCOM architecture will utilize dual polarization for its gateway or feeder links, and use of dual polarization is an option contemplated for the user links. However, an upgrade or replacement cycle of user terminals would be necessary to fully exploit this capability.

Several aspects of Virtual MILSATCOM methods and systems are most readily employed when a single customer uses a substantial majority of the capacity of the Virtual MILSATCOM network. The DoD is expected to be the primary user of Virtual MILSATCOM services, although it is expected that the capacity will also be available to other U.S. government agencies, both civilian and military. It is also possible that the Virtual MILSATCOM capacity could be shared with military allies of the United States, as is done with MILSATCOM systems operated by DoD today. In fact, because of the close integration of Virtual MILSATCOM with existing MILSATCOM assets from an operational perspective, such sharing agreements can readily be extended to include the Virtual MILSATCOM assets.

Notwithstanding the presence of non-DoD customers, this primary user focus enables the Virtual MILSATCOM operator to provide DoD substantial latitude in defining which orbital locations are populated, how the Virtual MILSATCOM operates with existing MILSATCOM assets, and how the coverage and capacity allocations of each Virtual MILSATCOM satellite are configured or modified over time.

This approach is a significant improvement compared to the current business practices that govern how the DoD acquires and uses COMSATCOM services. Although the DoD is a large user of commercial satellite bandwidth, it rarely controls the allocation of resources on a commercial satellite which is shared with the satellite operator's other customers. Nor does the DoD have any real latitude to change coverage patterns, again due to the pre-existing commitments the satellite operator has to its other customers. Also, since DoD typically acquires its capacity in small increments across many satellites, it is not easy to either coordinate acquisition of capacity or efficiently utilize it once it is procured.

DoD is exploring the use of hosted payloads to mitigate some of these limitations, but a hosted payload is not a complete solution. With a hosted payload, the DoD provides a separate sub-payload to be placed on the commercial satellite, and pays the satellite operator to integrate the sub-payload on the satellite. The DoD may also pay continuing charges, such as rent or other support service charges, during the period the satellite is in operation. This arrangement gives the DoD greater control over the tasking of its hosted payload, but the satellite is still a mixed use platform, and cannot easily be relocated if DoD needs change. In fact, the opposite can be true in that the commercial operator may move the satellite to another of its slots to meet its broader business needs, and this movement may compromise the usage of the hosted payload.

Virtual MILSATCOM satellites can be redeployed into any DoD or partner slot that has been coordinated for military X-band or Ka-band operations. Because of the primary customer focus and a satellites that are deployed with a relocation fuel reserve as addressed further below, the Virtual MILSATCOM operator can immediately respond to requests to relocate Virtual MILSATCOM satellites to meet changing DoD requirements that are not possible with either COMSATCOM or MILSATCOM assets. Surge capacity can be delivered quickly when needed.

FIG. 7 depicts an alternate orbital system 700 comprising eight WGS MILSATCOM satellites 710₁, 710₂, . . . 710₈ (collectively 710) and eight Virtual MILSATCOM satellites 715₁, 715₂, . . . 715₈ (collectively 715). Four of the Virtual MILSATCOM satellites 715₁, 715₃, 715₅ and 715₇ are co-located with existing MILSATCOM satellites 710₁, 710₃, 710₅ and 710₇, and four Virtual MILSATCOM satellites 715₂, 715₄, 715₆ and 715₈ fly “solo” in other orbital slots. FIG. 7 shows that under normal circumstances, the Virtual MILSATCOM satellites 715 would be distributed relatively evenly around orbital arc 750 to complement the pre-existing MILSATCOM capacity. In the illustrative system 700, the co-located WGS MILSATCOM (WGS) and Virtual MILSATCOM (VM) pairings 710₁ and 715₁ 710₃ and 715₃, 710₅ and 715₅ and 710₇ and 715₇, respectively, are embodied as providing 3875 MHz Ka-based and 1800 MHz X-band frequency communication by the WGS and 10,000 MHz X-band frequency communications by the VM. The solo WGS 710₂, 710₄, 710₆ and 710₈, respectively, provide 3875 MHz Ka-based and 1800 MHz X-band communications and the solo VM 715₂, 715₄, 715₆ and 715₈ provide 10,000 MHz X-band communication.

In FIG. 8, the assets of the system 700 of FIG. 7 are redeployed to a hypothetical “Africa Scenario” involving the deployment of U.S. forces to Africa. As shown for relocated system 800 in FIG. 8, two VM satellites 715₅ and 715₆ are relocated to be co-located with VM 715₄ and WGS 710₄, respectively, to support theater requirements. This repositioning creates a stacked pair of VMs 715₄ and 715₅ providing 20 GHz of capacity to the African theater for the duration of the mission. This repositioning also creates a new co-located pair of VM 715₆ and WGS 710₄. Once the mission in Africa is completed, the VM satellites 715₅ and 715₆ could be returned to their original normal deployment slots as shown in FIG. 7. Since VM uses DoD's pre-authorized and pre-coordinated slots, the only limitation on relocation is the time it takes to move the satellites 715₅ and 715₆ from one slot to another. As seen in FIGS. 7 and 8, while in some instances, VM satellites are co-located with WGS. In other instances, they are not. When not co-located, a VM satellite is still preferably controlled by a central control and command system controlling traffic that dynamically allocates and coordinates the spectrum and coverage patterns of the WGS and VM satellites of the overall network.

This operational flexibility is markedly improved as compared to both existing MILSATCOM and COMSATCOM. With the existing MILSATCOM, orbital relocation is possible, but the limited number of WGS satellites means that the relocation will leave a vacated region with significantly diminished capacity. Also, since WGS is a two-band (X- and Ka-band) system, relocation affects capacity and operations in both frequencies. In contrast, the single-band Virtual MILSATCOM asset allows DoD to separately optimize its X-band and Ka-band global capability.

The Virtual MILSATCOM approach employs a more capable propulsion system that that used today for either MILSATCOM or COMSATCOM. The propulsion system of a geostationary communications satellite performs four functions: orbit insertion, routine station-keeping, orbit relocation, and evasive maneuver. Orbit insertion is actually the last stage of the launch process. Launch vehicles usually deliver a satellite to a highly elliptical orbit, commonly referred to as a geostationary transfer orbit (GTO), also known more generically as a Hohman transfer orbit. The GTO has an apogee that is at or near geostationary orbit altitude, while the perigee may be as low as a few hundred miles. The geostationary orbit used for communications satellites is a circular orbit above the Earth's equator (zero degrees of inclination) at an altitude of 35,786 km or 22,236 miles. To optimize the orbital insertion, the launch vehicle usually puts the GTO apogee as close as possible to the intended geostationary orbit longitude. Using the satellite's main propulsion system, the perigee of the GTO is successively raised, and the orbital inclination of the satellite is reduced until the satellite is “circularized” in geostationary orbit (GEO). Orbit insertion requires a significant amount of thrust to change the orbit of the satellite.

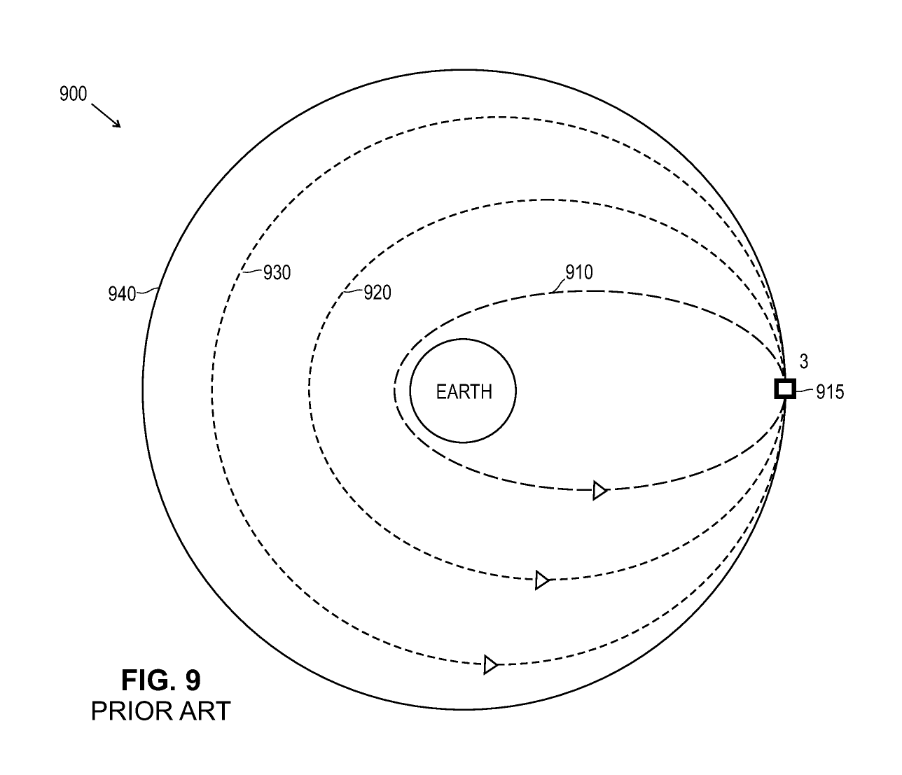

A process 900 of orbit insertion is depicted in FIG. 9. The launch vehicle delivers the satellite to GTO 910 and then separates from the satellite. When the satellite is at its apogee 915, its main propulsion is fired. The effect of this firing is to raise the perigee of the elliptical orbit. In this figure, two firings at apogee successively raise the perigee as shown by orbits 920 and 930, with the third raising the perigee to GEO 940 thereby circularizing the orbit 920 at GEO. The orbital maneuvers must also bring the orbital inclination of the satellite to zero degrees so that the satellite orbits above the equator.

Once a satellite is in its desired location, several small forces will cause an untended satellite to drift from its location. These forces include gravitational anomalies in the Earth, the effect of lunar gravity, and the effects of solar wind, for example. Station-keeping propulsion systems are used to keep the satellite from drifting out of position. Small thrusters are used to counter the satellite's tendency to slowly drift along the orbit, East-West station-keeping, or to counter “wobble” above and below the zero degree inclination of the geostationary orbit, North-South station-keeping. Most operators keep their satellites within a “box” that is within 0.1° of the desired location in both the East-West and North-South directions. Such consistency of location ensures optimum signal transmission performance between the satellite and the Earth-based terminals that are pointed at it, and maintains the separation from other satellites in orbit that is necessary to avoid interference in the transmissions of adjacent satellites. In normal operation, the amount of thrust to perform station-keeping is relatively small.

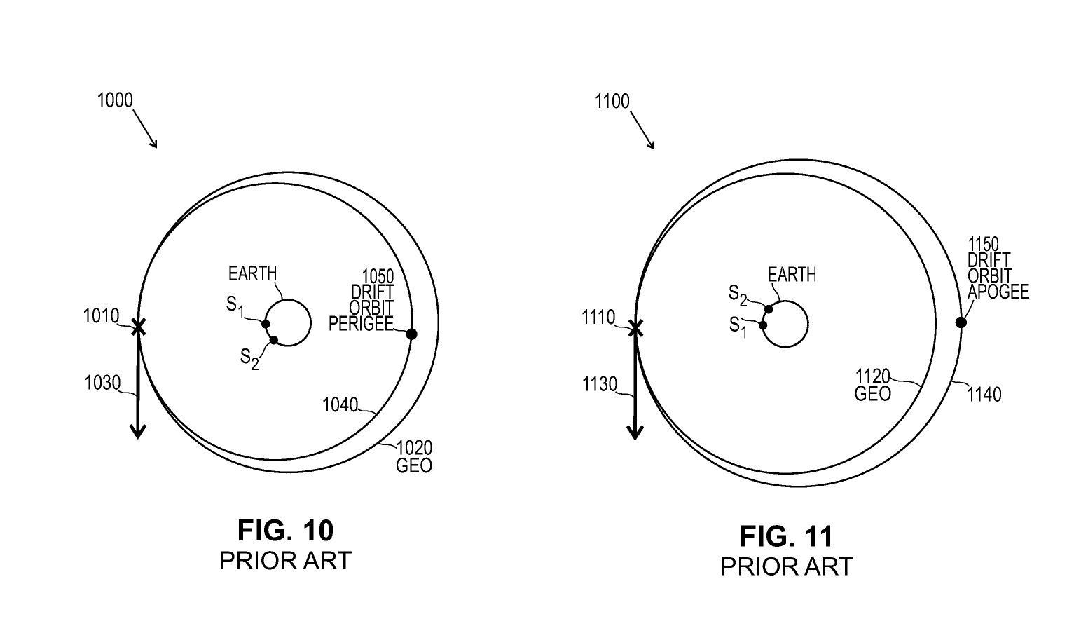

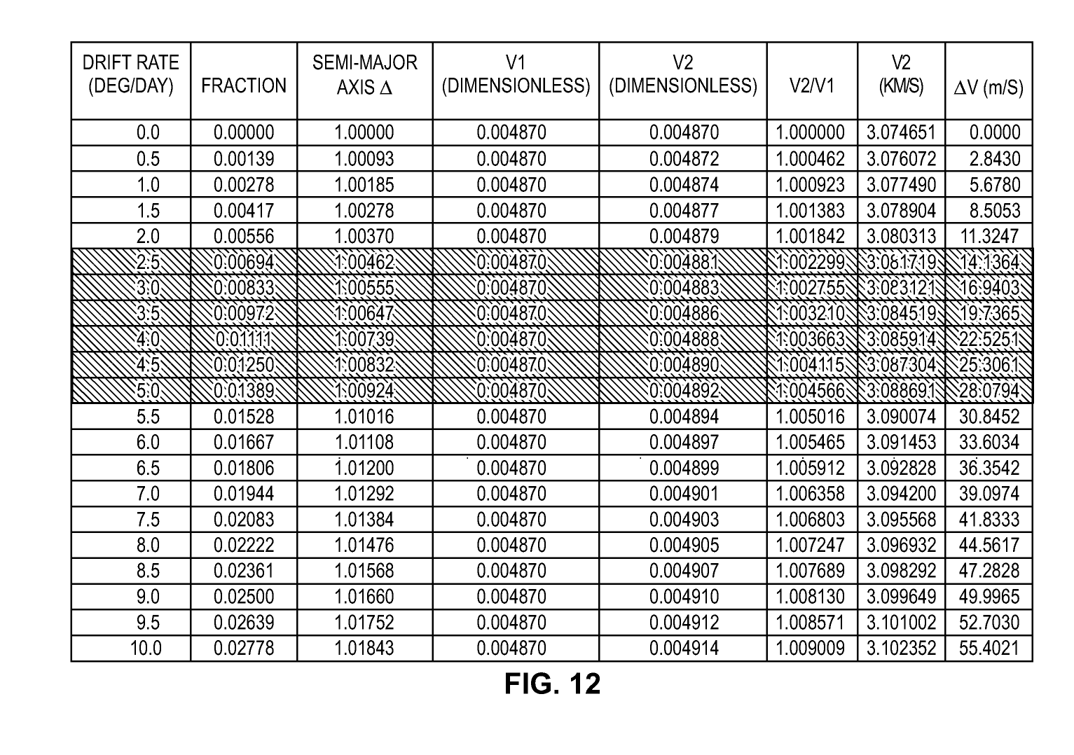

A satellite operator may choose to relocate a satellite from one orbital position to another. In order to relocate a satellite in geostationary orbit, satellite operators must temporarily modify the orbit of the satellite. Processes 1000 and 1100 for moving a satellite to the east or the west are depicted in FIGS. 10 and 11, respectively. The observer in FIGS. 10 and 11 is viewing the Earth from above the North Pole and the Earth, like the satellite, is rotating counterclockwise.

To move the satellite to the east, the propulsion system is used to lower the orbit of the satellite so that satellite drops into a faster orbit that will cause the satellite to advance to the east, as seen from the ground. At point 1010 marked with an X, the satellite, which is rotating the Earth in geosynchronous orbit 1020, above the subsatellite point s₁, in the direction of arrow 1030, fires one of its thrusters in the opposite direction of the arrow, decreasing the satellite velocity. As a result of the decreased velocity, the orbit of the satellite is changed to the inner trajectory 1040. The firing point 1010 becomes the orbit apogee or high point of the new orbit and 180° around the orbit the perigee 1050 or low point is lower than the GEO arc. The new period of rotation around the Earth is less than the 24 hour period of the Earth's rotation. As a result, when the satellite again returns to point 1010, X, 24−Δt hours later, the Earth has rotated less than one revolution and the point S₂ which is further to the east, is now the new subsatellite point. The drift is allowed to proceed for as many orbits as is required until the subsatellite point reaches the desired location, and the satellite propulsion system is fired again, this time in the direction of satellite travel 1030, speeding the satellite up and returning the orbit to the original GEO orbit, but above a new subsatellite point that is the desired amount east of the original location.

To move a satellite to the west as shown in FIG. 11, the satellite is boosted into an orbit above GEO where the orbital period exceeds one day and the satellite will appear to drift to the west as seen from the ground. At point 1110, marked X, the satellite is rotating the Earth in geosynchronous orbit 1120 above the subsatellite point s₁, in the direction of the arrow. Thrusters are fired to increase the satellite velocity. As a result of the increased velocity, the orbit of the satellite is changed to the trajectory 1140. The firing point 1110 becomes the orbit perigee or low point of the new orbit and 180° around the orbit the apogee or high point 1150 is higher than the GEO arc. The new period is greater than the 24 hour period of the Earth's rotation. As a result, when the satellite again returns to point 1110, X, 24+Δt hours later, the Earth has rotated more than one revolution and the point S₂ is now the new subsatellite point. The drift is allowed to proceed for as many orbits as is required until the subsatellite point reaches the desired location, and the satellite propulsion system is fired again, this time in the opposite direction of the satellite travel, slowing the satellite down and returning the orbit to the original GEO 1120 but above a new subsatellite point that is the desired amount west of the original location.

The time it takes to effect these maneuvers is determined by the amount of energy that is used, expressed as the change in velocity, ΔV. The amount of ΔV determines how much lower or higher the relocation orbit is with respect to GEO. The greater the ΔV, the greater the difference in the orbital period, and hence the relative drift rate of the satellite during one orbit. In simple terms, a more energetic burn will enable a faster relocation. In FIGS. 10 and 11, a faster drift rate would be depicted in orbit lower perigee (FIG. 10) or with higher apogee (FIG. 11).

The ability to move with deliberate speed to avoid collision with another object would essentially require the propulsion burn of a very high ΔV relocation, and as a result would consume a very large amount of propellant. The principal reason for such a maneuver would be to avoid a collision or with another object in space that was deliberately trying to collide with the satellite. In practice, this type of maneuver has not been necessary at geostationary orbits, as the satellites in the orbit do not move quickly relative to each other, and operators would have ample time to plan and execute orbit relocation maneuvers in the unlikely event one satellite did pose a threat to another. For example, in April 2010, the command system on Intelsat's Galaxy 15 satellite failed after a solar storm, and the satellite began to drift along the geostationary orbit. Other satellite operators were notified of the failure, and were able to track the Galaxy 15 satellite with great precision. Normal station-keeping maneuvers were all that were necessary to avoid collision.

Within the past decade however, some satellite operators, and in particular military space agencies, have begun to express concern about the ability of satellites to avoid hostile threats. In particular, the U.S. military has been concerned that both Russia and China have been developing antisatellite (ASAT) weapons that could collide with, or explode near, satellites in geostationary orbit. The ability to avoid an attack on a geostationary satellite is thus seen as a potentially valuable feature that would enhance the survivability of satellite communications networks.

Satellite designers have two propulsion technologies for performing these four types of maneuver: chemical propulsion and electric propulsion. Chemical propulsion, usually a hypergolic bipropellant system, has been standard practice for many decades. Bipropellant systems offer reliable and instantaneous high thrust, and hence provide quick acceleration. The principal disadvantage of bipropellant systems is that they are less efficient at producing thrust, so much more propellant is needed to achieve the same ΔV as an electric system. This extra mass translates into heavier satellite mass and higher launch costs. Electric propulsion, which uses ionized plasma, usually Xenon gas, is a newer technology. Electric propulsion is advantageous in that it delivers a much higher specific impulse (Isp). Hence, more thrust is derived from a unit of propellant mass. As a result, the mass of the satellite can be reduced by several hundred kilograms, and physical dimensions of the satellite may also be reduced. Both reductions translate into potentially substantial savings in launch costs. The principal disadvantage of electric propulsion is that it does not provide quick acceleration.

As a result the trend in recent years for both COMSATCOM and MILSATCOM satellites has been towards hybrid propulsion systems that use bipropellant for orbital insertion and electric propulsion for station-keeping and relocation. On the other hand, new all-electric designs have been available since 2012, and the first all-electric designs are now in orbit. For patient satellite operators who can wait several months after launch for a satellite to be available to deliver service and revenues, the cost:performance trade can be very attractive.

Virtual MILSATCOM employs a unique hybrid propulsion design that specifically enables added relocation and evasive maneuver capability. For the Virtual MILSATCOM system, neither standard hybrid propulsion systems nor all-electric propulsion systems will meet mission requirements. According to one aspect of the invention, the Virtual MILSATCOM propulsion system will deliver a much more robust set of capabilities, both in terms of maneuverability and the frequency of propulsion events; specifically, with respect to relocation of satellites on orbit and evasive maneuvers.

COMSATCOM operators typically relocate a satellite only a few times over its operating life, because customer requirements are fairly stable. In practice, many commercial satellites operate from a single location for their entire design life, and it is rare that a satellite would be relocated more than two or three times. Commercial requests for proposals (RFPs) usually specify a performance requirement to support three relocation maneuvers over the satellite's fifteen year design life. Further, COMSATCOM operators usually try to minimize fuel burn, since extra fuel can mean extra operating life and revenues if a satellite is otherwise healthy at the end of its design life.

When commercial satellites are repositioned, the standard drift rates are typically about 2.5° of orbital longitude per day. This drift rate represents a compromise between the speed of relocation and the cost, in terms of fuel expenditure, of performing the maneuver.

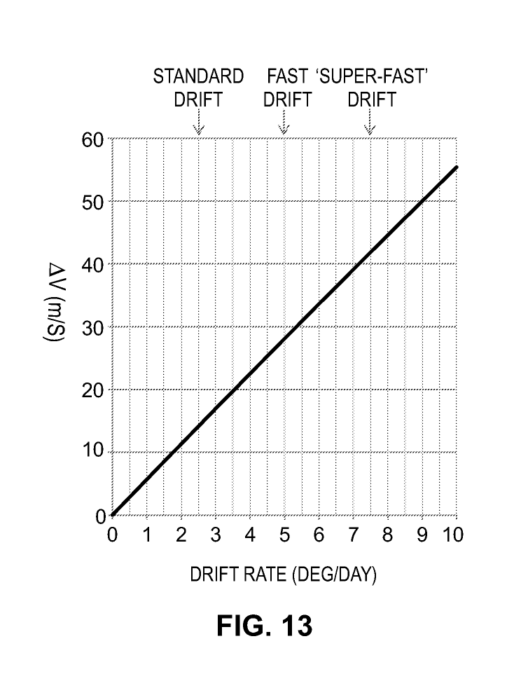

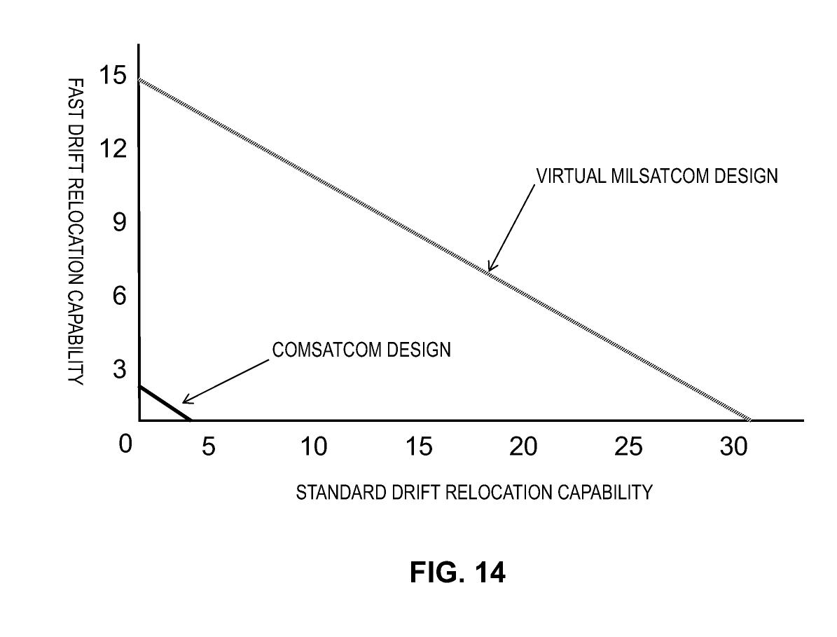

For Virtual MILSATCOM according to one aspect of the invention, frequent and fast orbital relocations are a desired feature. Thus, a propulsion design that delivers different capabilities than those normally specified by a COMSATCOM satellite operator is advantageously employed. An exemplary system for the Virtual MILSATCOM constellation is designed to provide user-selected drift rates—ranging from a “standard drift” rate of 2.5° per day up to a “fast drift” rate of 5.0° per day or more, as illustrated in FIGS. 12 and 13.

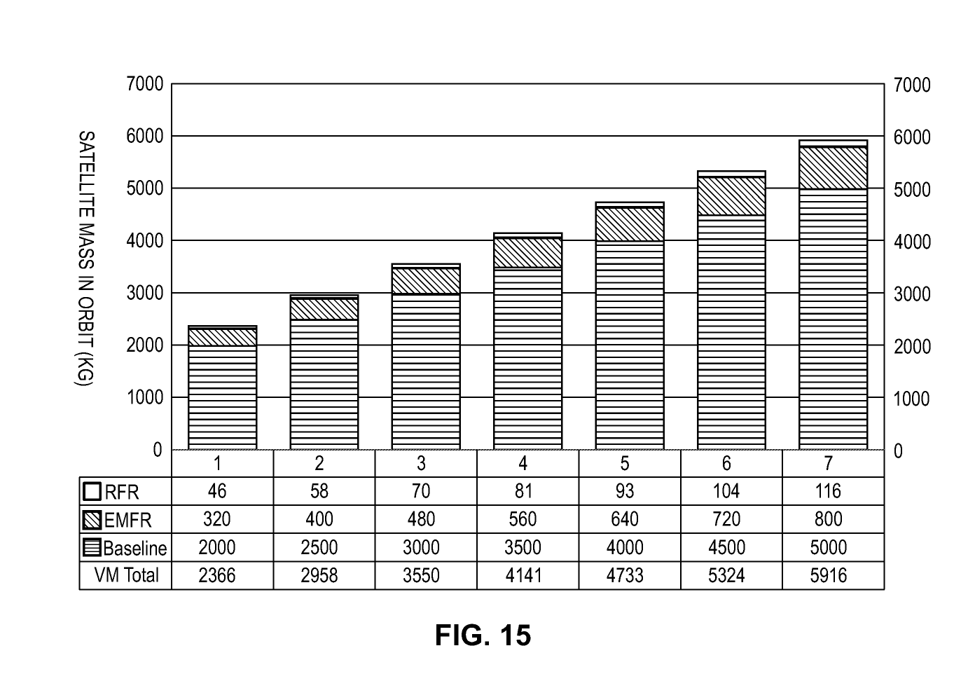

Further, the Virtual MILSATCOM satellite is intended to support many more relocation maneuvers than a typical communications satellite. An exemplary system for a Virtual MILSATCOM satellite would provide enough fuel to provide up to 15 fast drifts, an average of one per year over a fifteen year expected life time, or 30 standard drifts, an average of two per year, or any combination thereof. The fast drift relocation requires twice as much propellant to effect the relocation as the standard drift. This capability means that a Virtual MILSATCOM has roughly ten times the relocation capability of a typical communications satellite, as illustrated in FIG. 14.

The architectural design and operating model of the Virtual MILSATCOM orbital network enables the use of either a bipropellant or an electric propulsion system for orbital relocation. Electric propulsion is feasible and preferred because the Virtual MILSATCOM assets are often expected to be relocated relatively long orbital distances of sixty degrees or more. In essence, while electric propulsion does not provide the instant acceleration of bipropellant propulsion, sustained thruster operation allows for similar ΔV performance over time. Currently available thrusters would require approximately 16 hours to achieve a drift rate of five degrees per day, and another 16 hours to reverse that and reposition in GEO.

The propellant mass savings using electrical propulsion as compared with bipropellant are significant, and so the Virtual MILSATCOM design in accordance with one embodiment employs electric propulsion for orbital relocation. With the performance of electric thrusters currently available, a satellite with Virtual MILSATCOM relocation capability will require additional Xenon fuel that is equal to approximately 2-3 percent of the “baseline” mass of a satellite that was not equipped to provide this capability to provide the 15 fast drift or 30 standard drift maneuvers referenced above. For a satellite with a “baseline mass” of 2500 kg, this translates to a mass penalty 50-75 kg. The additional mass is referred to herein as the relocation fuel reserve (RFR). This compares very favorably with a bipropellant propulsion system. The equivalent bipropellant mass penalty would be as much as 40% of the baseline mass or an additional 1000 kilograms of fuel (2500 kg×40 percent).

For evasive maneuvers, however, electric propulsion does not provide enough acceleration to enable a satellite to dodge or avoid an incoming threat, and bipropellant must be used. As noted above, COMSATCOM satellites have not been designed for evasive maneuver. Nor has DoD yet designed any of its geostationary MILSATCOM satellites for evasive maneuver.

The specific maneuverability desired is a function of the threats that the Virtual MILSATCOM operator must mitigate. If a direct ascent ASAT weapon is fired at the Virtual MILSATCOM satellite, there would be time to perform a very high ΔV maneuver that could provide a drift of as much as one degree of orbital longitude per hour which is equivalent to approximately 500 miles at Geostationary Orbit Altitude. Other maneuvers, such as moving into a highly inclined orbit, are also possible. The bipropellant fuel load required to perform such a maneuver using the 2500 kg electric propulsion baseline discussed earlier is just over five percent for each evasive maneuver. If bipropellant is also used for the orbital insertion function, this same thruster can be used to perform the evasive maneuver provided the satellite is designed with the appropriate fuel reserve. An exemplary Virtual MILSATCOM design according to one embodiment of the invention includes a capability to do at least three such maneuvers at a mass penalty of approximately 16%, or roughly 400 kg using the example of a 2500 kg satellite. This capability is designated as the evasive maneuver fuel reserve (EMFR).

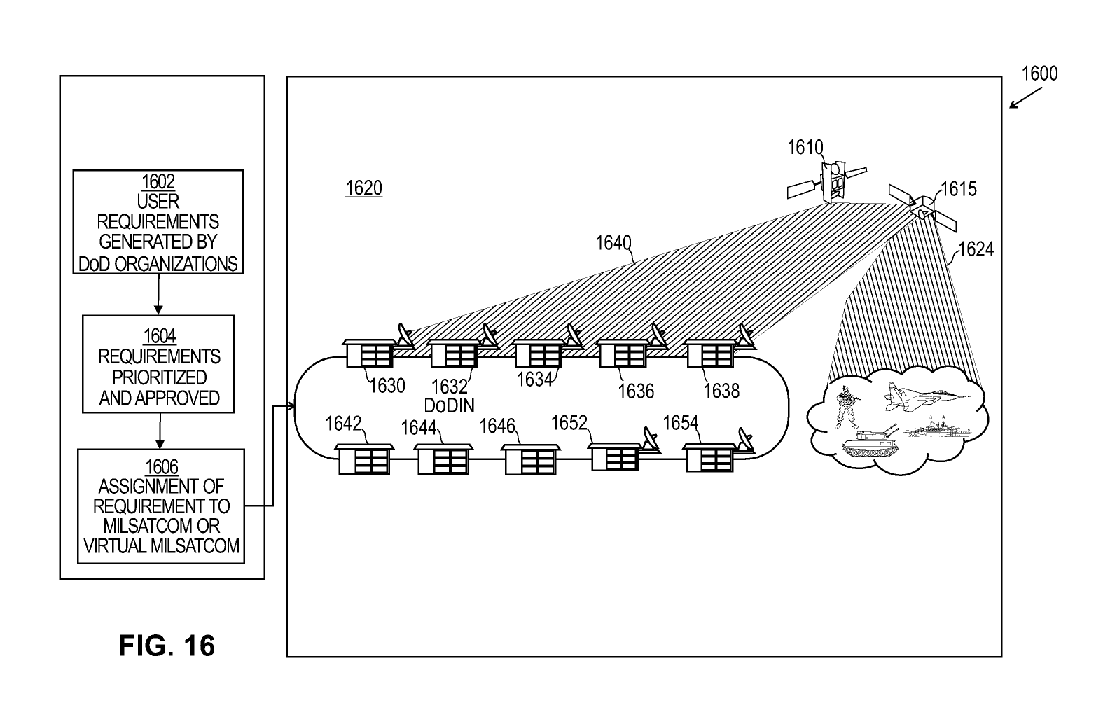

Thus, in one embodiment, the Virtual MILSATCOM satellite incorporates a heavier electric propulsion system and a heavier bipropellant propulsion system than would be utilized by a typical communications satellite. The total mass penalty is some 18 percent, as illustrated in FIG. 15. Thus, if the baseline satellite was 2500 kg, the Virtual MILSATCOM satellite with RFR and EMFR would be closer to 3000 kg. With average launch costs of $13-20,000 per kilogram to GTO, this capability translates to an increase in launch costs of $6.5-10M dollars per satellite. This approach has not been pursued by commercial operators, because frequent relocation and evasive maneuvering are not economically justified.

To offset the higher launch costs associated with this design, one instance of the Virtual MILSATCOM approach includes charging customers an “RFR Fee” for each orbital reassignment and an “EMFR Fee” for each evasive maneuver. The price established for these fees is determined as a function of the cost and consumption of the RFR and EMFR, respectively. For example, since approximately 90% of the mass penalty is associated with the EMFR, these events are likely to be more expensive than RFR events. A bipropellant fueled EMFR will consume approximately 30% of the combined extra fuel mass (90%/3), whereas an electric fueled RFR will consume approximately one half of one percent of the extra fuel mass (10%/15 or 10%/30). For the Virtual MILSATCOM operator, EMFR or RFR reserves that have not been consumed at the end of the satellite's fifteen year design life can be used to extend mission operations if the satellite is otherwise healthy. Each EMFR event consumes the equivalent of approximately two years of station-keeping fuel using bipropellant, and each RFR event consumes approximately five months of station-keeping fuel using Xenon. Virtual MILSATCOM provides the first instance of this design and operational approach to geostationary satellite orbit relocation.

The Virtual MILSATCOM operator will permit the DoD to play a significant role in the day-to-day operation of the satellite payload, up to and including full control of planning, scheduling, tasking and monitoring the communications bandwidth and signals, with the Virtual MILSATCOM ground systems co-located with, or physically integrated with, existing wideband MILSATCOM Network Operations Centers (NOCs). This approach is a unique feature that is enabled by the dedicated customer focus of Virtual MILSATCOM and by the fact that the Virtual MILSATCOM operator will be a fully U.S.-owned, U.S.-operated, and U.S.-sourced entity.

Virtual MILSATCOM's company-owned, customer-operated model gives DoD the opportunity to co-locate Virtual MILSATCOM's ground-based network operations centers (NOCs) at existing MILSATCOM NOCs. A logical place for co-location is with the WGS Wideband Satellite Operations Centers, also known as WSOCs. Five of these NOC facilities are currently deployed worldwide. They provide the primary gateway forward and return paths for the WGS network. A similar capability could be installed to support any specified number of Virtual MILSATCOM satellite payloads from any one site. Virtual MILSATCOM NOCs are designed with sufficient capacity to serve as back-ups for other NOCS, thus providing robust redundancy in the ground payload operations segment. The Virtual MILSATCOM operator could also locate its primary and backup satellite operations centers (SOCs), which control the satellites in orbit at a secure location employing either leased space at a DoD facility or another DoD-approved location. This architecture enables the DoD to fully integrate Virtual MILSATCOM into its network planning and operations, and to seamlessly manage and allocate its traffic among existing MILSATCOM satellites and Virtual MILSATCOM satellites.

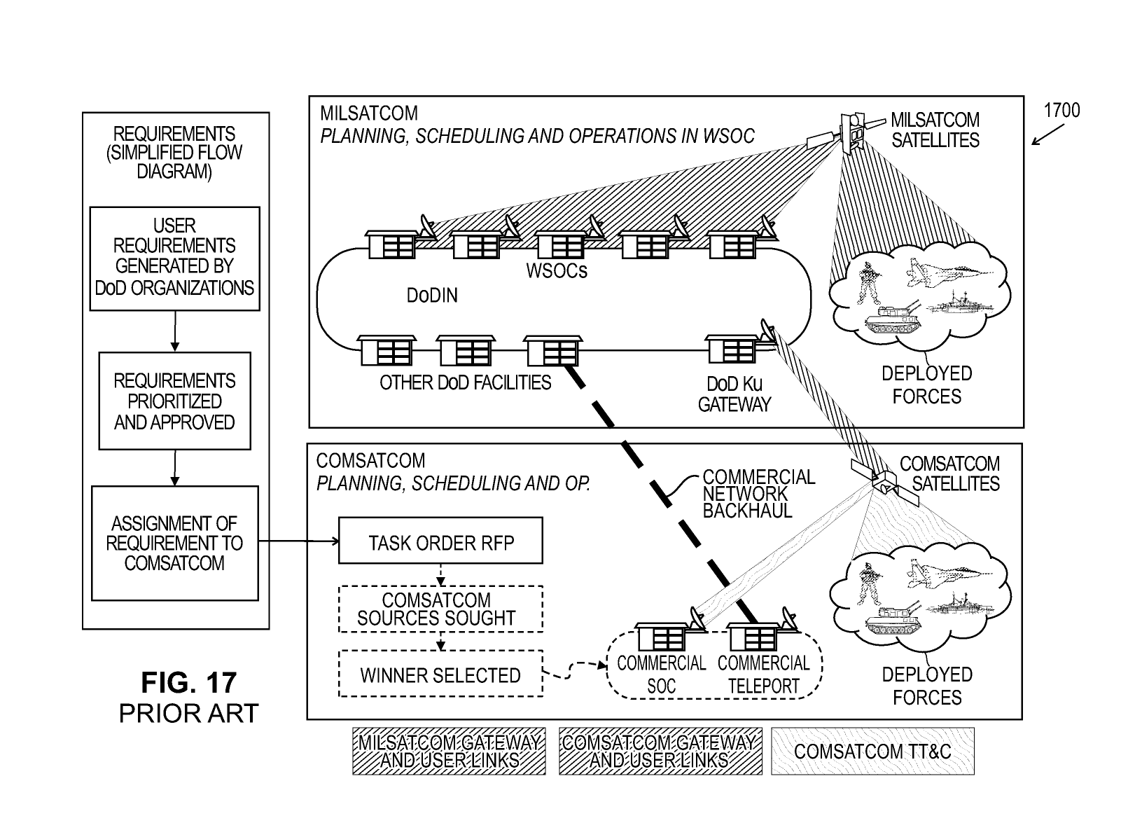

The process of resource allocation and MILSATCOM and Virtual MILSATCOM system 1600 are depicted in simplified form in FIG. 16. From the DoD user's perspective, Virtual MILSATCOM capacity can be allocated and operated using the same processes and personnel used to access MILSATCOM assets. In step 1602, user requirements are generated by DoD organizations. In step 1604, requirements are prioritized and approved. In step 1606, an assignment of requirements to MILSATCOM or Virtual MILSATCOM is made. As further shown in FIG. 16, an integrated architecture 1620 is implemented to support the assigned requirements.

As illustrated in FIG. 16, deployed forces 1622 communicate with MILSATCOM and Virtual MILSATCOM satellites 1610 and 1615, respectively, using user link 1624. MILSATCOM and Virtual MILSATCOM control facilities are all located at DoD sites, and are directly connected to the secure Department of Defense Information Network (DODIN) 1621. WSOCs 1630, 1632, 1634, 1636 and 1638 reside on the DODIN and communicate with satellites 1610 and 1615 utilizing gateway link 1640. Other DoD facilities 1642, 1644 and 1646, as well as, the Virtual MILSATCOM Spacecraft Operations Centers (VMSOC) 1652 and Payload Operations Control Center (POCC) backup 1654 are also part of the architecture 1620. VMSOC 1652 and POCC 1654 also reside on the DODIN and communicate with Virtual MILSATCOM satellite 1615 providing control of the satellite and the programming of the digital channelizer/beamformer (TT&C) as described above, as well as further below. While two satellites 1610 and 1615 are shown for ease of illustration, it will be recognized that additional satellites may be and likely will be deployed, as shown in FIGS. 7 and 8, for example.

In the architecture 1600, the Virtual MILSATCOM operator's main control facilities are located on DoD sites. These include the primary and backup VMSOC 1652 which monitors and controls the flight of the Virtual MILSATCOM satellite 1615 and the primary and backup POCC 1654 which is responsible for the configuration of the digital channelizer and beamformer payload. User operations, which include functions such as planning, scheduling, authorization and monitoring of user communications links, can be integrated within the existing WGS network operations centers (NOCs), which in the WGS system are known as Wideband Space Operations Centers (WSOCs) 1630, 1632, 1634, 1636 and 1638. Close integration of user communications between WGS and Virtual MILSATCOM provide DoD with greater coordination, optimization and visibility of a larger wideband network comprising both WGS and the Virtual MILSATCOM payloads. Alternatively, the Virtual MILSATCOM operator can staff and run its own NOCs also located on DoD sites, if that is the customer's preference.

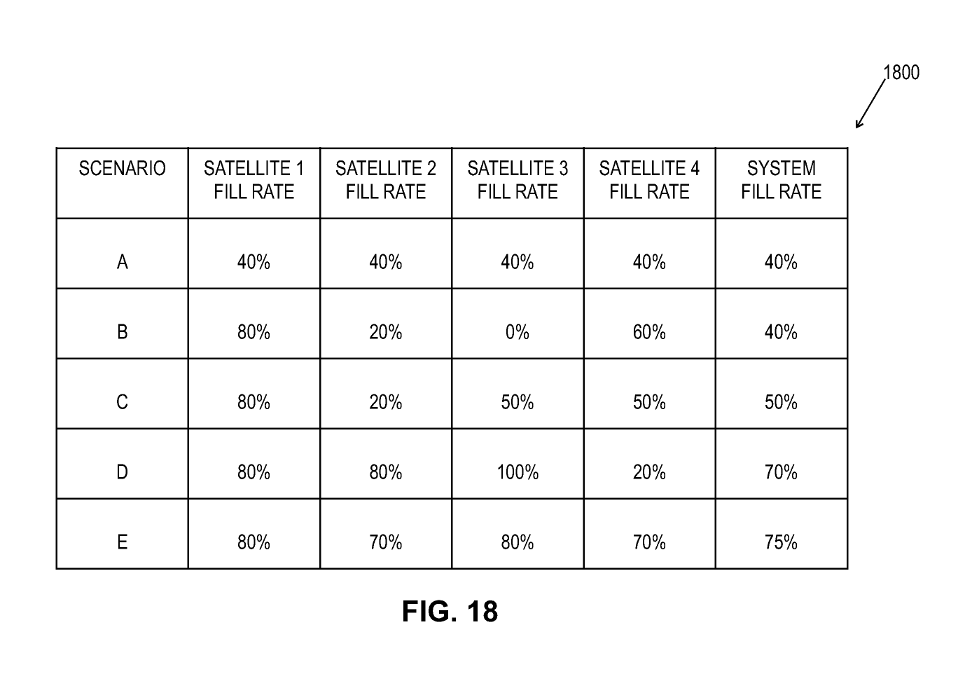

This approach contrasts significantly with how COMSATCOM capacity is typically acquired and managed today, which is depicted in simplified form in process and architecture 1700 of FIG. 17. Many COMSATCOM activities are performed outside of DoD's secure facilities and operational control, as discussed further below. Today, when DoD determines that it cannot meet a requirement with MILSATCOM assets, it procures COMSATCOM capacity from contractors or satellite operators using the joint GSA/DoD FCSA contract vehicle or a special purpose contract. DoD requirements are transmitted to FCSA contractors in the form of a task order request for proposal (RFP). The contractors then operate as middlemen to identify and secure capacity from the COMSATCOM operators, and to provide any additional network services required to provide the new capacity or serve the end users such as network design, provision of commercial satellite communications terminals, or the like. Most task orders are competitive, and many contractors may attempt to develop multiple solutions for the requirements of the task order. To respond to the RFPs, contractors must shop the requirement with commercial satellite operators, the majority of which are not U.S.-owned entities, and whose personnel are not U.S. citizens. Foreign satellite operators often establish separate subsidiaries under a proxy board or space security arrangement (SSA) structure to mitigate risks. However, this secure sub-entity must still interact with the larger, non-U.S. parent. The result is that the requirement is widely distributed through an unsecured satellite operator community. Such security concerns are eliminated in the Virtual MILSATCOM approach.

Further, once a COMSATCOM contract is awarded, the DoD traffic will be monitored by the commercial satellite operator's NOCs and teleports to ensure that it is operating within nominal parameters of the satellite and not interfering with other transponders and customers of the satellite, or with other satellites. While the DoD traffic will be encrypted, the transmission is, of itself, an observable indicator of activity that is visible to the operator's personnel. The satellite operator's facilities will likely be staffed with foreign nationals, and it is not a given that these operators will maintain the personnel and network security standards required on DoD networks. Finally, if the DoD does not already possess gateway terminals that can access the commercial satellite, the DoD must either procure and install a new ground terminal, or route its traffic over commercial terrestrial communications links to reach a commercial teleport that points at the satellite. The former adds cost every time a new commercial satellite is added to DoD's COMSATCOM network, while the latter creates additional security vulnerabilities in the end-to-end communications pathway.

Beyond security concerns, the COMSATCOM approach also generates complexity and inefficiency in terms of overall network management and control. For example, a military customer that has acquired capacity for a specific mission may have idle periods where that capacity could be used by another customer, but that idle capacity may not be visible to other military users. DoD is attempting to coordinate acquisition and operations to avoid waste, but monitoring the capacity on a real-time basis is very difficult when the capacity is procured from multiple contractors, who in turn purchase capacity from dozens of satellite operators owning hundreds of satellites with widely varying performance parameters.

One embodiment of a Virtual MILSATCOM system and process in accordance with the present invention uses a unique pricing model for commercial satellite communications services purchased by the Department of Defense or other governmental customers. Two advantageous key features of this model are (1) a system level pricing structure that enables customers to move their usage across an entire satellite fleet without incurring substantial economic penalties; and (2) the opportunity to develop pricing structures that provide customers with predictable pricing or expenditure profiles.

Virtual MILSATCOM offers a much simpler and more flexible pricing model that will generate significant savings and flexibility for its customers. This model is possible because Virtual MILSATCOM is a global system that is dedicated to one primary customer.

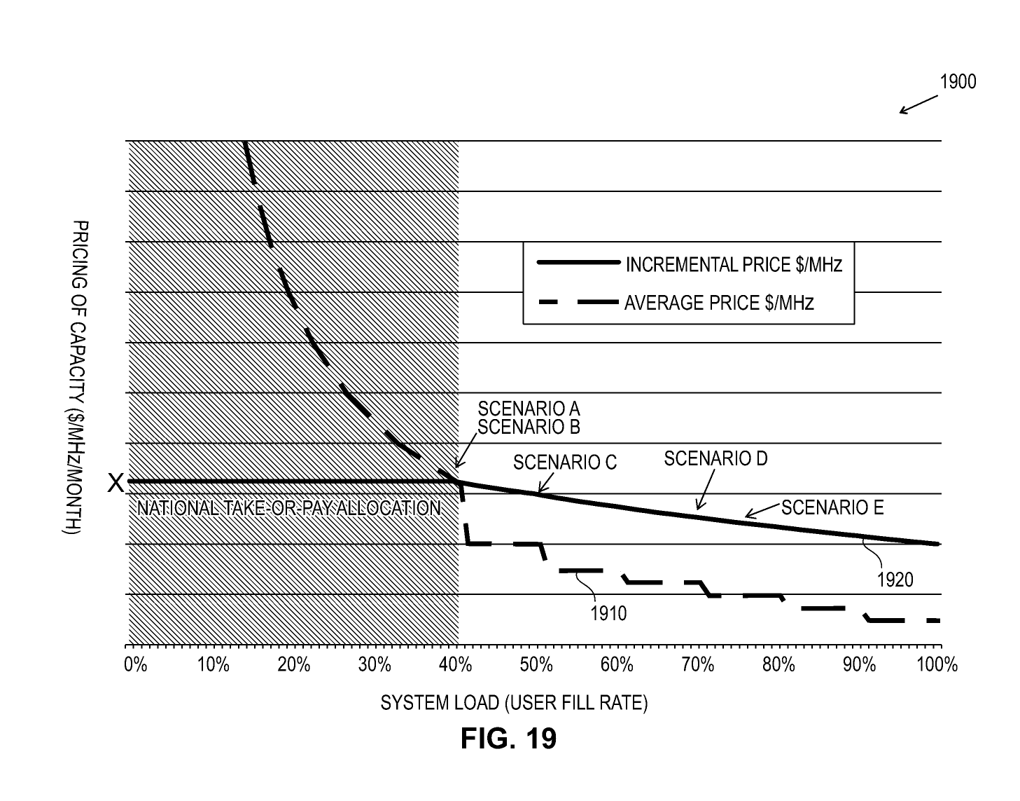

In the Virtual MILSATCOM model, the system fill rate that is used to determine pricing is based on the average fill rates of all satellites in a Virtual MILSATCOM network. FIG. 18 shows a table 1800 illustrating five scenarios A-E for a Virtual MILSATCOM network comprising four satellites. In FIG. 18, a satellite fill rate (SFR) is determined on an average monthly usage of configured satellite capacity, and the system fill rate equals the summation of each SFR divided by the number of satellites, (Σᵢ₌₁ⁿ SFRᵢ)/n. In scenario A and scenario B, the same system fill rate (40%) is achieved, but the actual utilization of the satellites varies significantly. With the Virtual MILSATCOM pricing model the price paid by the customer is the same for both. In the COMSATCOM model the shift from scenario A to scenario B would require the purchase of additional capacity on satellite 1 and satellite 4, and leave the customer with substantial unused capacity on satellite 2 and satellite 3. The additional purchase of 40% of capacity on satellite 1 and 20% of capacity on satellite 4 would result in additional costs of nearly 40% assuming constant pricing as compared with the Virtual MILSATCOM approach. The sum of the required payments for the rates for the four satellites supporting both scenarios utilizing a typical COMSATCOM approach would be equal to a 55% fill rate on the Virtual MILSATCOM network: (80%+40%+40%+60%)/4=55%; 55%/40%=1.38.

Rising system fill rates on a Virtual MILSATCOM network are also a usage indicator which may be indicative of a potential need to deploy additional Virtual MILSATCOM satellites. The Virtual MILSATCOM operator will discuss expansion requirements with the DoD whenever projected demand reaches 70-75% of the Virtual MILSATCOM system's capacity. Thus, scenarios D and E reflect utilization rates which, if sustained by DoD, would cause the Virtual MILSATCOM operator to discuss plans for an additional satellite to meet rising demand.

The Virtual MILSATCOM network is intended to operate with excess capacity that can be accessed when circumstances require. Whereas COMSATCOM operators seek a load factor of 80-90% utilization, the Virtual MILSATCOM model is intended to operate at 60-70% load factor during routine operations, thereby having a much larger buffer to meet transient or surge needs. Further, as noted previously, the utilization factor is determined across the entire satellite system. As a customer. DoD is free to place and move its traffic where needed, and is not contractually obligated to use a specific satellite, or a specific transponder. Significant increases in demand beyond the available capacity of a single satellite can be met with the relocation of another satellite to the geographic area with the surge in demand as addressed above in connection with the discussion of FIGS. 7-15, for example.

Traditional commercial wideband satellite leases allocate specific capacity to the customer, such as a specific satellite, with pre-determined beam coverage, transponder and bandwidth assignment, or the like, for a pre-determined lease period. At any point in time, the DoD may have hundreds of such leases with each lease individually specified, competed, negotiated, managed, and audited. Such leases may be provided at any given time by dozens of independent COMSATCOM suppliers. If the DoD's geographic needs shift, new capacity must be acquired, and if an existing lease is no longer needed, the contractual terms for an orphaned lease must still be met until the term of the lease is completed.

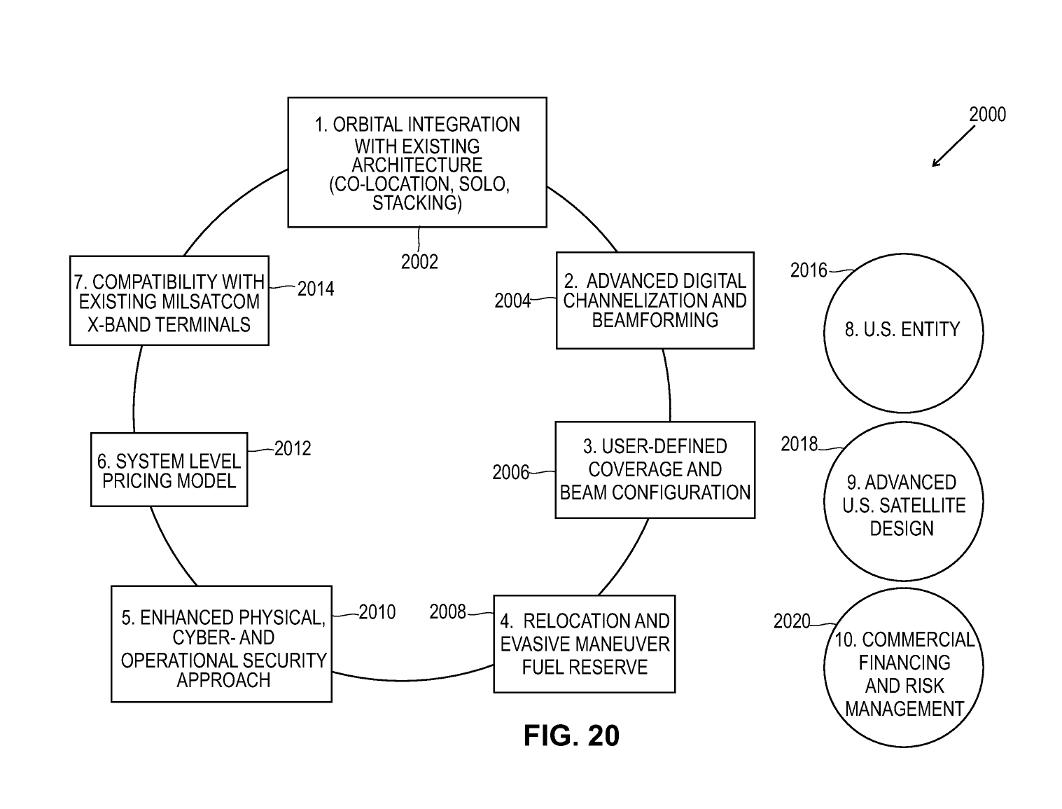

The Virtual MILSATCOM approach enables the operator to offer innovative pricing structures that would benefit the Virtual MILSATCOM customer. An exemplary pricing schedule 1900 is presented in FIG. 19. In this example the operator charges a take-or-pay fee for a baseline increment of total system capacity sufficient to meet annual operating expenses and capital depreciation. The pricing structure would be determined prior to the construction and launch of a Virtual MILSATCOM satellite or satellites, so DoD would in effect be able to lock in a pricing schedule for the entire life of the satellites comprising the network. It would therefore know well in advance what the price of any level of Virtual MILSATCOM service utilization would be, and planning and budgeting could proceed accordingly. For example, if the take-or-pay fee was based on utilization of 40% of the system, and the Virtual MILSATCOM architecture comprised four satellites, then the floor fee would be the equivalent of usage of 40% of the capacity of four satellites. DoD would have unlimited flexibility to use this capacity where needed across all Virtual MILSATCOM satellites in the network. Since in one embodiment a single network management system is tracking usage on the entire network, a usage charge based on actual system-level usage can be generated on a monthly basis.

For usage above the take-or-pay obligation, Virtual MILSATCOM operator could propose a declining incremental price for capacity, up to full utilization of the system. Marginal and average prices would therefore decline as system loading increased above the take-or-pay threshold. Customers will see unit costs decline as usage increases. Dashed line 1910 shows an average price in $/MHz and solid line 1920 shows an incremented price in S/MHz, where the pricing of capacity in $/MHz/Month is plotted with respect to percentage system utilization or user full rate. In this schedule, take-or-pay cost is calculated as a price “X” based on a utilization of 40% of the available system capacity. This price is charged as a fixed charge, regardless of actual utilization, until system fill rates reach 40%. Once the system utilization exceeds 40%, the incremental price drops as illustrated with each additional 10% of system load, resulting in a reduction of average price as additional capacity is used.

This pricing model provides the customer with a beneficial and predictable pricing structure, especially valuable during periods when transient demand spikes. This approach is in marked contrast with how COMSATCOM is normally priced. With COMSATCOM, normal supply and demand mechanisms lead to higher prices when capacity runs short, and this is evident in today's COMSATCOM markets. Often, the price for the last available transponder on a satellite can be two or three times more expensive than the first, especially if the term of the lease is of a short duration.

Other users of the Virtual MILSATCOM system can either be incorporated into the principal customer's pricing schedule, or can have a separate pricing schedule established with the Virtual MILSATCOM operator. For example, non-DoD, US government customers, may find it preferable to negotiate capacity agreements and pricing directly with the primary Virtual MILSATCOM customer(s). Similarly, foreign government organizations may prefer to enter into usage agreements directly with the primary Virtual MILSATCOM customer or customers. In this event, DoD pays the Virtual MILSATCOM operator for the capacity used by other customers, and those customers would in turn reimburse the DoD based on the terms of their agreement. Alternatively, DoD and other customers may prefer that non-DoD customers establish contracts directly with the Virtual MILSATCOM operator. In this instance, the pricing schedule for other users might be different from that of the primary customer or customers.

The Virtual MILSATCOM approach can also utilize other pricing approaches. For example, if the primary customer wishes to have a highly predictable expenditure profile, the take-or-pay threshold could reflect a higher implicit level of utilization, such as 70%, or could simply be structured as a flat rate for unlimited use. In this instance, it is possible that a single agency within the DoD would serve as the broker for all non-DoD customers.

Because the Virtual MILSATCOM model uses existing military satellite communications frequencies and will be compatible with existing military satellite communications waveforms, the capacity will be immediately accessible to the large population of military satellite terminals in service, initially in X-band, but also potentially in Ka-band. DoD estimates that there are currently more than 1000 active terminals that can access X-band, and hundreds of multi-band terminals that can utilize X-band as well as other frequencies. There are also a large number of terminals that can use X-band with the changeout of the terminal's modular satcom modem and amplifiers to X-band. Further, because of the COCO network operations construct, existing terminal networks can be managed within the current DoD management architecture, rather than being taken off network to connect to an external X-band satellite system.

In contrast, use of COMSATCOM networks usually require DoD to purchase commercial frequency satellite terminals, for example commercial Ku-band or commercial Ka-band, or to retrofit military terminals for operation on commercial frequencies. Even when the COMSATCOM system operates on X-band, user equipment must be reconfigured to operate through a satellite that is not operated as an integrated MILSATCOM asset. With Virtual MILSATCOM, the ground terminal accesses a WGS satellite or a Virtual MILSATCOM satellite interchangeably.

In addition, Virtual MILSATCOM gives the Department of Defense several opportunities and incentives to improve its existing X-band communications network. Because the existing WGS X-band capacity is limited, there has been little impetus to make investments that improve the military's ability to exploit the spectrum. While new coding and waveforms have been developed for UHF, Ka-Band and EHF satellite communication, there have been few changes to the waveforms supported by DoD's X-band terminals. The availability of ubiquitous X-band capacity can be expected to change this dynamic, and DoD may therefore decide to make better use of this precious spectrum resource. One easy improvement that DoD has already explored is the incorporation of dual polarization on future X-band payloads. It will be recalled current WGS uses only a single polarization. Dual polarization would allow for a two-fold increase in capacity with frequency reuse. With the added capacity and footprint flexibility that Virtual MILSATCOM affords, such investments will become more attractive. As noted above, the Virtual MILSATCOM architecture intends to use dual polarization for its gateway links. The gateway beams can be used to support the testing of dual polarization user terminals, and evolution of the Virtual MILSATCOM satellites could then incorporate dual polarization into the user links on future satellites.

The Virtual MILSATCOM operator will preferably be U.S. owned and operated, and it is planned that this U.S. entity will preferably procure all of the satellites, launch services, and ground facilities from U.S. sources. U.S. ownership and staffing of the Virtual MILSATCOM operating company provides an additional discriminator in the provision of global Virtual MILSATCOM services. As a U.S. owned and operated company, the Virtual MILSATCOM operator can establish the necessary clearances for personnel and facilities as required by DoD, without the extra cost and administrative burdens associated with foreign suppliers, such as the need for special security arrangements (SSAs), proxy boards, or the need to develop a national interest determination (NID) to use U.S. taxpayer monies on a foreign source of supply.

The Virtual MILSATCOM operator will preferably rely exclusively on U.S. hardware suppliers for satellites, launch services, ground systems, support services, and the like. This U.S. provisioning provides the Department of Defense with added confidence in the security and reliability of its sources of supply. It also means that the Virtual MILSATCOM operator is fully compliant with the “Buy American” provisions of Federal Acquisition Regulations, and as such, will enjoy a favorable pricing differential vis-à-vis non-U.S. sources. In contrast, most COMSATCOM operators use satellites, launch vehicles and ground facilities that have been acquired from both the U.S. and other countries to support their operations.

The all U.S. nature of the Virtual MILSATCOM operator also enables the use of NSA Type 1 encryption hardware, considered the world's best for securing the satellite's command and data handling systems from cyber threats. This equipment is difficult, if not impossible to export. Hence, current COMSATCOM systems do not incorporate this capability, and given the international supplier base of today's global COMSATCOM operators, it may never be possible for those operators to provide a Type 1 level of security.

Virtual MILSATCOM will preferably use a new class of satellite buses. The highly efficient Virtual MILSATCOM payload is ideal for this new class of satellite bus. These smaller buses also enable the Virtual MILSATCOM operator to take advantage of a new generation of low cost U.S. launchers that provide launch services at a significant discount to those associated with the current USAF Evolved Expendable Launch Vehicle (EELV) program. By using U.S. owned, non-EELVs, the Virtual MILSATCOM operator avoids competing for limited launch slots available for higher value national security space payloads.

The use of these smaller, lighter, and less expensive satellites also is congruent with emerging DoD thinking on the future of military space assets. It is recognized that under the current approach, DoD may be reaching both economic and operational limits with respect to MILSATCOM acquisition and operations. Ever larger satellites cost more to manufacture and launch, take longer to develop and deploy, concentrate risk of loss during launch and in-orbit, and also present core targets for military adversaries seeking to disrupt or destroy critical command and control capabilities. The smaller, single frequency satellites embedded in the Virtual MILSATCOM architecture distribute capacity over a larger number of smaller assets, thus substantially reducing launch and operational risks.

The Virtual MILSATCOM architecture also provides a critical improvement in resiliency, which the DoD defines as the ability to operate in contested or hostile environments. The most basic enhancement to resiliency is the increase in the number of satellites available to DoD for MILSATCOM. The Virtual MILSATCOM architecture adds resiliency by using reconfigurable spot beams which make the satellite inherently more resistant to jamming. When combined with the orbital relocation capabilities discussed above in connection with FIGS. 7-15, it is clear that Virtual MILSATCOM greatly enhances the robustness of DoD's satellite communication architecture.

Resiliency is also enhanced via the commercial acquisition model in which construction and launch is feasible within 30-36 months. The Virtual MILSATCOM constellation of satellites can be expanded incrementally and efficiently as demand grows, and the use of insurance enables quick replacement of assets that have failed on orbit.

Private-sector funding of the Virtual MILSATCOM architecture is an advantageous element of supporting rapid and cost-effective delivery of services to the DoD. The budget of the Department of Defense is under pressure, with painful choices between end force size and structure, and between readiness and modernization needs. DoD does not have the fiscal resources to develop additional required satellite capacity. The Virtual MILSATCOM model does not require large, up-front investments by DoD. Instead, it anticipates a usage-based budgeting approach in which satellite capacity is acquired much like any other utility or consumable. The DoD already engages in this practice in its purchase of COMSATCOM through its O&M and working capital funds. Virtual MILSATCOM could use the same funding approach, but delivers a much more secure, flexible and capable resource. In essence, the Virtual MILSATCOM capacity becomes a third layer in the DoD's satellite communication network: (1) traditional MILSATCOM, (2) Virtual MILSATCOM, and (3) COMSATCOM. Operationally, the Virtual MILSATCOM capacity resembles MILSATCOM. In terms of budget planning, it resembles COMSATCOM, while delivering incremental capacity at a substantially lower per-unit cost than either.

The Virtual MILSATCOM operator may suitably access the commercial insurance market to mitigate the financial risk associated with building, launching and operating the Virtual MILSATCOM network. This feature provides DoD with added assurance that launch failures and/or on-orbit anomalies will have minimal impact on the viability of the Virtual MILSATCOM operator or the capacity it is providing. This approach is in marked contrast to MILSATCOM assets, where a launch or on-orbit failure must be fixed via an unplanned emergency investment in an expensive replacement satellite.

The Virtual MILSATCOM business offers superior methods and systems for expansion of DoD's wideband satellite communication resources. This approach combines the superior innovation cycle and cost advantage of the commercial market, the operational superiority of the military satellite communications model, and operations and pricing models that are entirely unique.

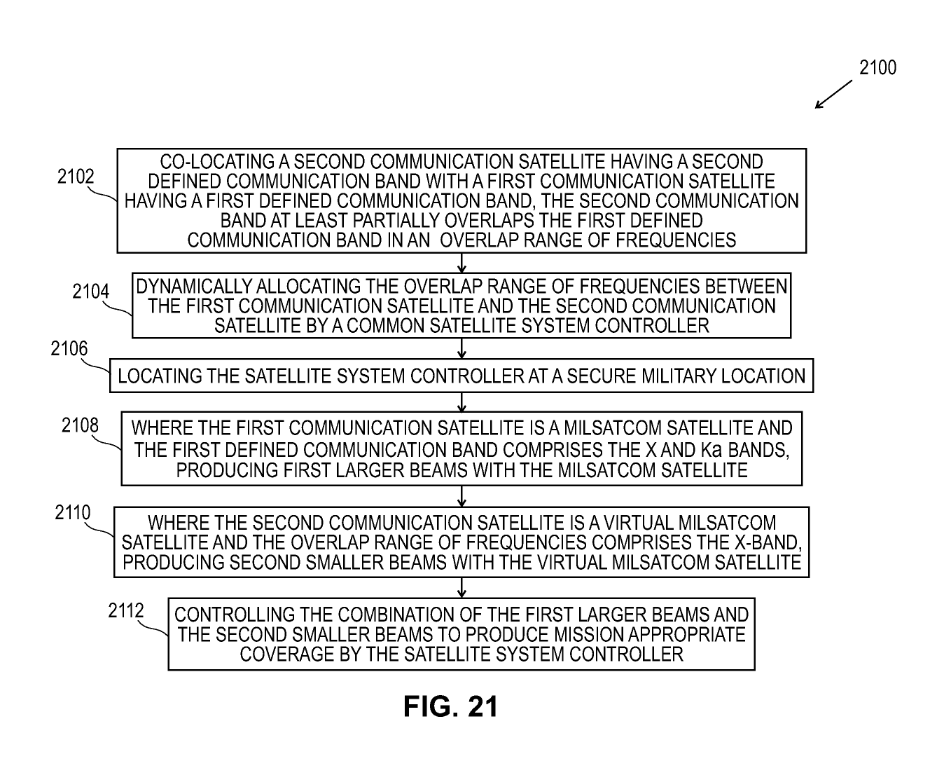

FIG. 20 illustrates a Virtual MILSATCOM feature table 2000. Features of the Virtual MILSATCOM feature table 2000 provide an integrated and reinforcing architecture that delivers needed capacity in a manner that enhances value to the Department of Defense across the key performance metrics of capacity, responsiveness, flexibility, security and affordability. An advantageous aspect related to delivering these capabilities is their provision by a U.S. entity that can leverage advanced U.S. technical knowhow and private capital and risk management markets.

Of the ten features of table 2000 of FIG. 20, orbital integration of MILSATCOM and Virtual MILSATCOM satellites 2002, user-defined coverage and beam configuration 2006, relocation and evasive maneuver fuel reserve 2008, enhanced physical, cyber and operational security approach 2010, and system level pricing model 2012 are unique to the Virtual MILSATCOM approach. Neither traditional MILSATCOM nor COMSATCOM systems operate in this manner. The use of advanced digital channelization and beamforming 2004 as defined in this application has never been applied to X-band MILSATCOM. Full, secure operational compatibility with existing X-band networks 2014 has never been accomplished with a non-MILSATCOM system. Underlying these features are design features that apply uniquely to the Virtual MILSATCOM approaches, such as a U.S. entity 2016 making it possible for the Virtual MILSATCOM operator to support DoD requirements in a manner that is virtually impossible for foreign-owned COMSATCOM operators. The use of all-U.S. content 2018 further strengthens the ability of the Virtual MILSATCOM operator to meet unique security and operating requirements of the DoD. Commercial financing and risk management 2020 both enables the Virtual MILSATCOM operator to move with greater speed and innovative efficiency that a traditional government development program, but also to better manage financial and operational exposure.

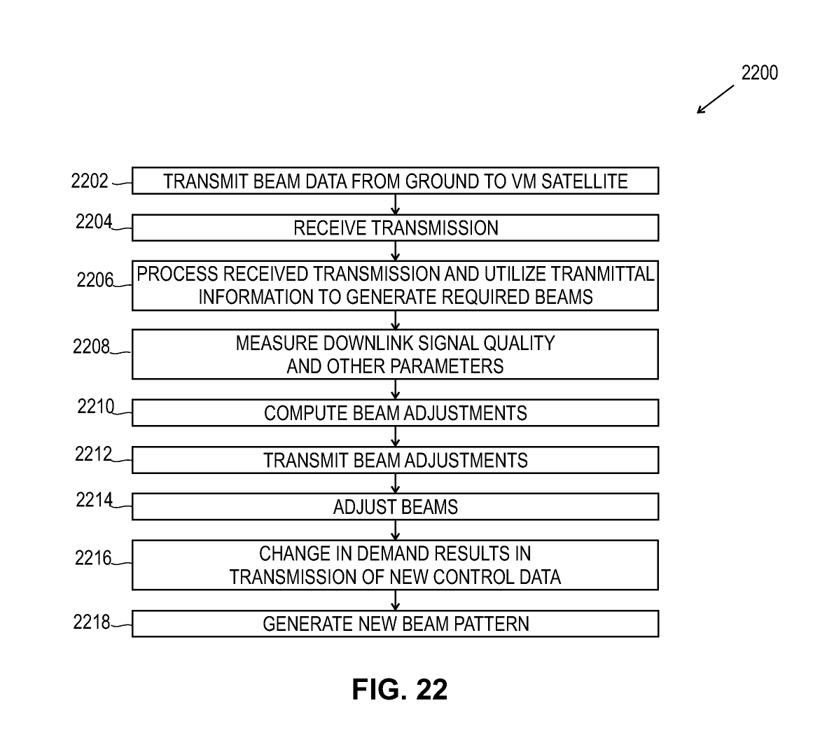

FIG. 21 illustrates a further method 2100 in accordance with one embodiment of the invention. In step 2102, a second communication satellite having a defined communication band or bands is co-located with a first communication satellite having a defined communication band or bands, the bands of the second communications satellite at least partially overlap the defined communication band or bands of the first communications satellite. In step 2104, the overlap range of frequencies is dynamically allocated between the first communication satellite and the second communication satellite by a common satellite system controller.

In step 2106, the satellite system controller is preferably located at a secure military location. In step 2108, the first communication satellite is a MILSATCOM satellite and the first defined communication band comprises the X and Ka bands, and the method 2100 further comprises producing first larger beams with the MILSATCOM satellite. In step 2110, the second communication satellite is a virtual MILSATCOM satellite and the overlap range of frequencies comprises the X-band, and the method 2100 further comprises producing second smaller beams with the Virtual MILSATCOM satellite. In step 2112, the combination of the first larger beams and the second smaller beams is controlled to produce mission appropriate coverage by a satellite system controller, such as controller 130, or by a satellite controller, such as controller 118.

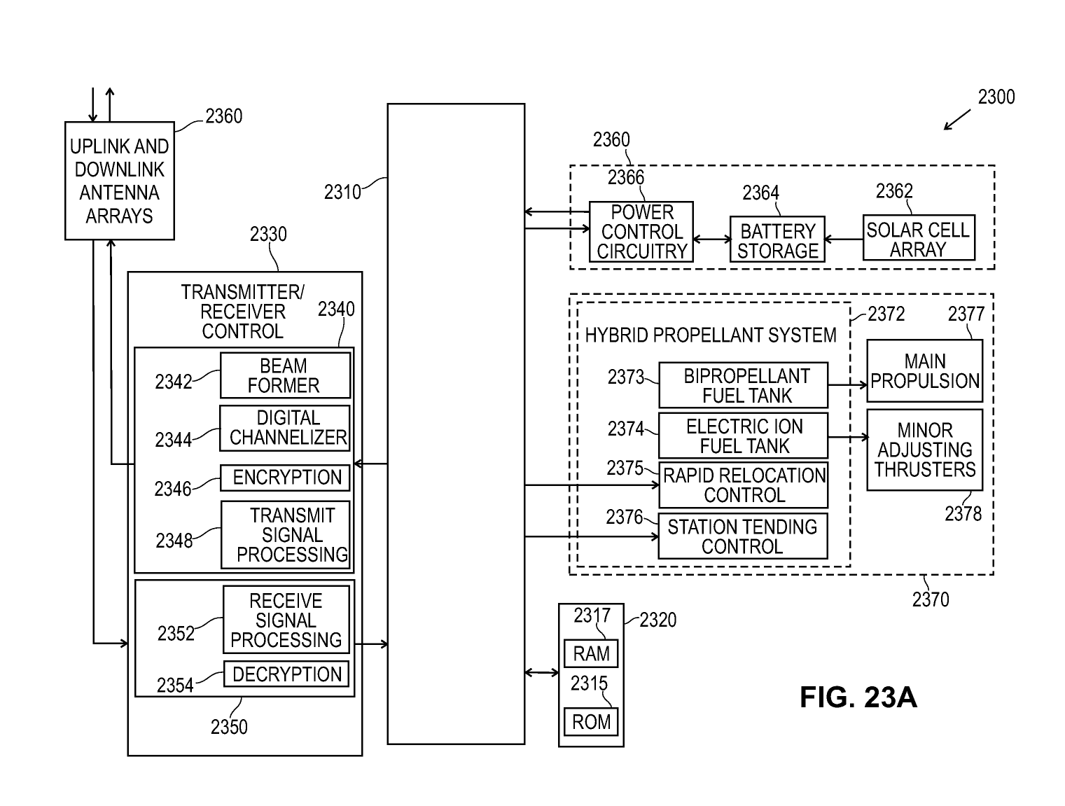

FIG. 22 shows a further process 2200 of controlling a Virtual MILSATCOM system in accordance with the present invention. In step 2202, a ground transmitter, such as transmitter 120 of FIG. 1, transmits the shape and diameter of each of a plurality of beams to be transmitted by a VM satellite, such as any one of satellites 115, 215, 315, 715₁, . . . ₈, or 1615, for example. In addition, the ground transmitter preferably transmits how much bandwidth is to be carried within each beam and the power level of the transmission in each beam. For example, small beams can be generated in areas with high traffic density, while larger beams can be generated for areas with low traffic demand. More generally, whatever beams are required by the context can be generated as needed, as discussed further above.

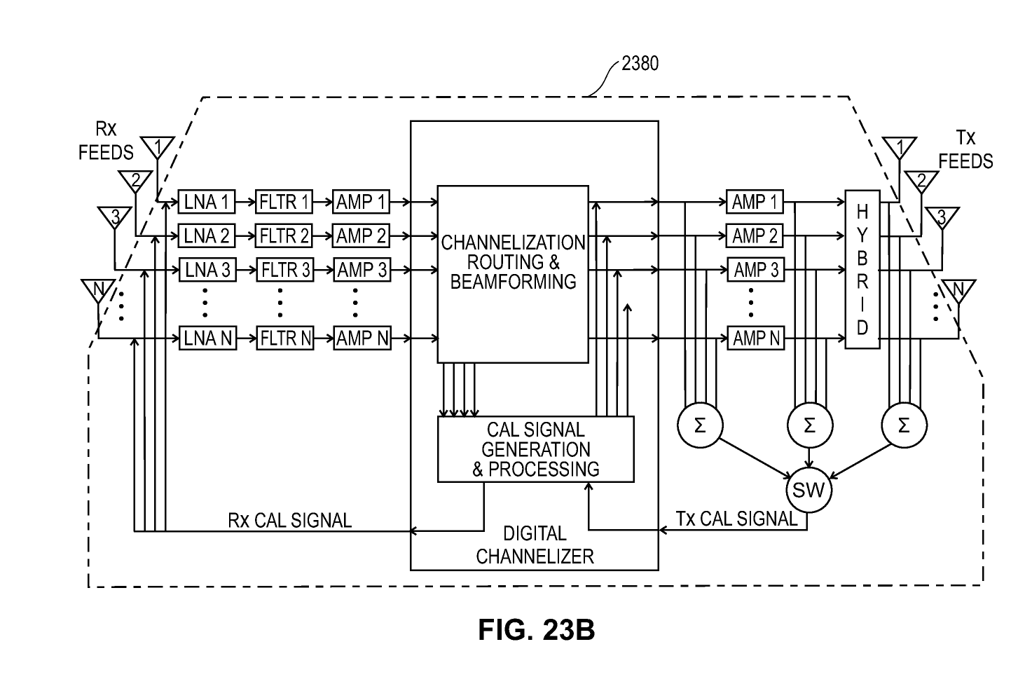

In step 2204, the VM satellite receives the command transmission of step 2202. A processor, such as the processor 2310 of FIG. 23A, in the VM satellite processes the transmission and utilizes the transmitted information to generate the required beams which are then transmitted in step 2206 utilizing the downlink antenna array. In step 2208, signal quality and other parameters are measured on an ongoing basis by ground users and data is fed back to the satellite system controller associated with the ground transmitter. In step 2210, necessary beam adjustments are computed and transmitted in step 2212 so that the VM satellite can adjust the beams in step 2214.

If a change in demand occurs as discussed in connection with FIGS. 7 and 8 or a desire for a specialized beam formation arises as discussed in connection with FIGS. 5 and 6, for example. Then, in step 2216, new beam formation control command data is transmitted to the VM satellite and appropriate adjustments are made. In the scenario of FIGS. 7 and 8, a VM satellite, such as either satellite 715₅ or 715₆, processes a relocation request, fires its propulsion system and relocates as discussed in detail above. Then, in step 2218, a new and appropriate beam pattern is generated. For the scenarios of FIGS. 5 and 6, no relocation may be needed, but unique and appropriate beam patterns are generated as needed in step 2218.

FIG. 23A shows an exemplary satellite controller 2300 for use in any of the Virtual MILSATCOM satellites described above, such as one of VM satellites 115, 215, 315, 715₁, . . . ₈, or 1615. In FIG. 23A, a programmed microprocessor or processor 2310 executes programming instructions stored in ROM 2315 and utilizes data from RAM 2317 of memory 2320 to perform the functions described herein. While a single processor is shown for ease of illustration, it will be recognized that functions to be performed by the VM satellite may be spread across multiple processors, ASICs, FPGAs, control circuits and software modules or some combination of the above as desired with a suitable level of backup memory, processing and software employed as required by the environment.

As further seen in FIG. 23A, processor 2310 provides control inputs to and receives inputs from transmitter and receiver control block (T/R control block) 2330. T/R control block 2330 includes transmitter control 2340 and receiver control 2350. The transmitter control 2340 utilizes the frequencies allocated to the VM satellite as directed by the processor 2310. For example, in an embodiment as in FIG. 1 where MILSATCOM satellite 110 of FIG. 1 is allocated nMHz of 500 MHz of X-band bandwidth as controlled by ground transmitter 120, processor 2310 directs the utilization of the remaining (500-n)MHz of bandwidth. Similarly, in an embodiment as in FIG. 3, processor 2310 directs utilization of (500-n)MHz in the region where MILSATCOM satellite 310 and VM satellite 315 overlap, and the full 500 MHz outside the area of overlap. Beam former circuitry 2342 controls the downlink antenna array 2360 to provide beam formation as required by embodiments, such as those shown in FIGS. 2-6, for example. Digital channelizer 2344 provides digital channelization to support more efficient bandwidth usage as discussed above. FIG. 23B shows a block diagram of a digital channelizer beamformer 2380 that may suitably be employed to provide the functions of blocks 2342 and 2344 of FIG. 23A. Encryption is provided by encryption module 2346. As addressed above, with U.S. ownership and implementation as addressed herein, an encryption such as Type 1 encryption subject to export contracts can be suitably and advantageously employed. Further transmit signal processing can be applied by transmit signal processing module 2348. For example, left handed and right handed polarization may be employed to double frequency utilization as addressed above. The downlink antenna arrays of uplink and downlink antenna array 2360 communicate with users on the ground as further addressed herein.

Uplink communication, as well as, satellite system commands, are received by uplink antenna arrays of the uplink and downlink antenna arrays 2360. For example, beam forming command data is received to provide processor 2310 with the data needed to form beams like those discussed in connection with FIGS. 2-6, for example. Received signal processing circuitry 2352 and decryption module 2354 of receiver controller 2350 process received signals appropriately.

A solar cell array 2362 provides charging power to battery storage 2364. Power control circuitry 2366 completes electrical power system 2360 which is controlled by processor 2310. System 2360 provides power to processor 2310, as well as, for all of the systems of the VM satellite.

A propulsion system 2370 includes a hybrid propellant system 2372 as discussed above including a bipropellant fuel tank 2373 including additional fuel sufficient to power standard rate relocations, rapid rate relocation, as well as, evasive maneuvers, and an electric ion propulsion fuel tank 2374 including additional fuel to power station keeping adjustments, as well as, standard rate and rapid rate relocations. Rapid relocator control module 2375 and station tending control module 2376 control rapid relocation and station tending position adjustments by power module propulsion thruster 2377 and minor adjusting thruster 2378, respectively.

The control system 2300 provides a user selected drift range from a standard drift rate of approximately 2.5° per day to a fast drift rate of approximately 5.0° per day or more. To this end, fuel tank 2374 preferably holds enough fuel, such as Xenon, to provide up to 15 fast drifts or 30 standard drifts. However, to support evasive maneuvers as discussed above, the fuel tank 2373 preferably includes an evasive maneuver fuel reserve to do at least three evasive maneuvers as addressed further above.

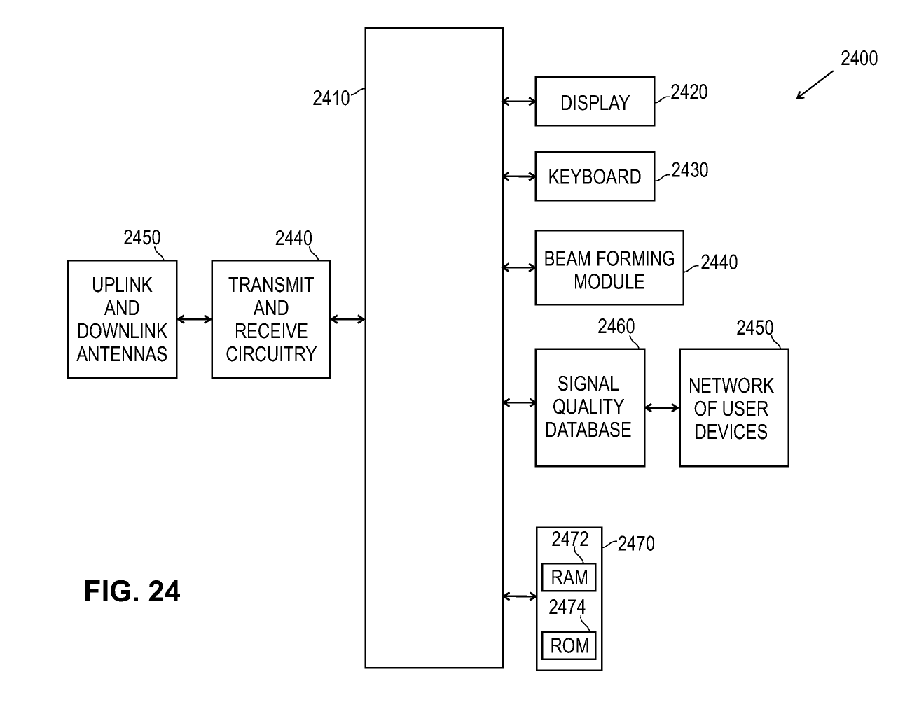

FIG. 24 shows an exemplary block diagram of a satellite system controller 2400, which may suitably be employed as controller 130 in FIG. 1 or in conjunction with ground control communication with any of the VM satellites 115, 215, 315, 715₁, . . . ₈, or 1615, for example. Satellite system controller 2400 includes display 2420 which may suitably be a touch screen display for providing outputs to a user, as well as, receiving inputs therefrom. For example, display 2420 may display a menu of selections to be selected by touch by the user, such as a number of special beams such as those shown in FIGS. 4-6, for example. A keyboard 2430 is another form of user input. For example, if a radar tracking system detects an attack on a satellite, the user may key in a command to execute an evasive maneuver and the processor 2410 causes transmit and receive circuitry 2440 to direct uplink antennas of uplink and downlink antennas 2450 to transmit the evasive maneuver command and data. System 2400 also transmits data for relocations occurring at a standard rate or a fast rate as discussed further above.

A beam forming module controls the data and software for processor 2410 to send beam forming commands to the VM satellite.

Additionally, a network of user devices 2450 provides signal quality data for communication with the VM satellite to a signal quality database 2460 which processor 2410 uses to adapt the beam forming spots generated by the VM satellite on an ongoing basis.

Memory 2470, including RAM 2472 and ROM 2474, holds data and program instructions which when executed by processor 2410 cause it to perform the functions described herein.

Those of skill in the art will appreciate from the present disclosure additional, alternative systems and methods for adapting the described approaches to new communication contexts and adopting evolving satellite and communication improvements, in accordance with the disclosed principles of the present invention. Thus, while particular embodiments and applications of the present invention have been illustrated and described, it is to be understood that the invention is not limited to the precise construction and components disclosed herein and that various modifications, changes and variations which will be apparent to those of ordinary skill in the art may be made in the arrangement, operation and details of the method and apparatus of the present invention disclosed herein without departing from the spirit and scope of the invention. For example, the Virtual MILSATCOM business model is initially planned to utilize X-band frequencies, but can also be adopted for other MILSATCOM satellite constellations, such as those that utilize UHF, Ka-band, and EHF frequencies.

We claim:

1. A satellite communication system comprising:
a first communication satellite having a first defined communication band;
a second communication satellite co-located in orbit with the first communication satellite and having a second defined communication band at least partially overlapping the first defined communication band in an overlap range of frequencies;
a satellite system controller for dynamically allocating the overlap range of frequencies between the first communication satellite and the second communication satellite.

2. The satellite communication system of claim 1 wherein the first communication satellite is a MILSATCOM satellite and the first defined communication band comprises the X band, or the X band and Ka band.

3. The satellite communication system of claim 2 wherein the second communication satellite is a Virtual MILSATCOM satellite and the overlap range of frequencies comprises the X-band.

4. The satellite communication system of claim 1 wherein the satellite system controller is physically located at a secure military location.

5. The satellite communication system of claim 3 wherein the MILSATCOM satellite produces first larger beams and the Virtual MILSATCOM satellite produces second smaller beams of variable size, shape and bandwidth, and the satellite system controller controls the combination of the first larger beams and the second smaller beams to produce mission appropriate coverage.

6. The satellite communication system of claim 3 wherein the Virtual MILSATCOM satellite Produces beams covering a second area encompassing and larger than a first area in which the MILSATCOM satellite produces beams, the satellite system controller allocating all the first defined communication band to a Virtual MILSATCOM satellite in an area in hich the second area does not overlap the first area.

7. The satellite communication system of claim 1 further comprising:
additional pairs of co-located first and second satellites, and wherein the system controller is further operable to control at least one of the additional second satellites to temporarily move to a different co-location with a different first satellite to meet a specific mission surge in demand.

8. The satellite communication system of claim 1 wherein the second communication satellite further comprises beam forming control software and control circuitry to cause the second communication satellite to generate more tightly focused communication beams than the first communication satellite in response to control signals from the satellite system controller.

9. A satellite communication method comprising:
co-locating a second communication satellite having a second defined communication band in orbit with a first communication satellite having a first defined communication band, the second defined communication band at least partially overlapping the first defined communication band in an overlap range of frequencies; dynamically allocating the overlap range of frequencies between the first communication satellite and the second communication satellite by a common satellite system controller.

10. The satellite communication method of claim 9 wherein the first communication satellite is a MILSATCOM satellite and the first defined communication band comprises the X and Ka bands.

11. The satellite communication method of claim 10 wherein the second communication satellite is a Virtual MILSATCOM satellite and the overlap range of frequencies comprises the X-band.

12. The satellite communication method of claim 9 further comprising:
locating the satellite system controllers at secure military locations.

13. The satellite communication method of claim 11 further comprising:
producing first larger beams with a MILSATCOM satellite;
producing second smaller beams of varying size, shape and bandwidth with a Virtual MILSATCOM satellite; and
controlling the combination of the first larger beams and the second smaller beams to produce mission appropriate coverage by the satellite system controller.

14. The satellite communication method of claim 13 further comprising:
supporting a communication protocol employing frequency cross-strapping utilizing the MILSATCOM satellite.

15. The satellite communication method of claim 9 further comprising:
employing additional pairs of co-located first and second satellites; and
controlling by the system controller at least one of the additional second satellites to temporarily move to a different co-location with a different first satellite to meet a specific mission surge in demand.

16. The satellite communication method of claim 9 wherein the second communication satellite further comprises beam forming control software and control circuitry, and further comprising:
generating more tightly focused communication beams than the first communication satellite by the second communication satellite.

17. A method of setting a price for one principal customer for usage of a virtual military satellite communication system comprising:
calculating average system utilization on a periodic basis;
establishing a take-or-pay fee based on a predetermined percentage of utilization of total capacity of said system;
establishing a declining incremental price for additional capacity, up to full utilization of said system; and
billing on a periodic basis the take-or-pay fee, where the predetermined percentage is not exceeded, and billing based upon the calculated average system utilization and the declining incremental price where an added amount to the take-or-pay fee where the predetermined percentage is exceeded.

18. The method of claim 17 wherein the one principal customer is the DoD, and the predetermined percentage is approximately 40%.

19. The method of claim 18 wherein said total capacity of the virtual satellite communication was contributed to the system by being built out by a private party.

20. The method of claim 17 further comprising:
determining if the calculated average system utilization exceeds a second higher predetermined amount on an ongoing basis; and
adding to the total capacity of the virtual military satellite communication system based upon said determination.

21. A satellite communication system comprising:
a MILSATCOM satellite having a first defined communication band and orbiting in a first DoD geostationary orbital slot;
a Virtual MILSATCOM satellite orbiting in a second DoD geostationary orbital slot dynamically operating in conjunction with the MILSATCOM satellite;
a central control and command system controlling traffic that dynamically allocates and coordinates the spectrum and coverage patterns of the MILSATCOM satellite and the Virtual MILSATCOM satellite.
